(19) United States
(12) Patent Application Publication
(10) Pub. No.: US 2011/0097562 A1
(43) Pub. Date: Apr. 28, 2011

(54) THERMALLY INSULATING FILMS AND LAMINATES

(75) Inventors: Jochen Brill, Speyer (DE); Thomas Musiol, Maxdorf (DE); Ulrich Schalkowsky, Speyer (DE); Olivier Enger, Ludwigshafen (DE); Bernd Ziegler, Goennheim (DE)

(73) Assignee: BASF SE, Ludwigshafen (DE)

(21) Appl. No.: 12/999,353

(22) PCT Filed: Jun. 17, 2009
(86) PCT No.: PCT/EP2009/057533

§ 371 Date: Dec. 16, 2010

(30) Foreign Application Priority Data
Jun. 17, 2008 (EP) 08158398.1

(51) Int. Cl. B32B 7/02; B44C 1/17; E04B 1/80; B05D 3/10; B32B 27/08; B32B 27/40; B32B 15/088; B32B 17/10; C08F 24/00

(52) U.S. Cl. 428/212; 156/235; 252/62; 427/160; 428/412; 428/423.1; 428/423.3; 428/423.7; 428/424.2; 428/424.4; 428/424.6; 428/424.8; 428/425.5; 428/425.6; 428/425.8; 526/268

(57) ABSTRACT

The present invention relates to films and laminates which shield thermal radiation and are based on IR-reflective liquid-crystalline layers, to a process for the production thereof, to pigments comprising them and to a composition which comprises a particular chiral dopant.

The present invention relates to films and laminates which shield thermal radiation and are based on IR-reflective liquid-crystalline layers, to a process for producing them, to pigments comprising them and to a composition which comprises a particular chiral dopant.

The problem of shielding thermal radiation arises especially in the insulation of residential, commercial or industrial constructions. Buildings with generous window areas, especially in summer and in particular in southern areas, quickly heat up to such an extent that they have to be cooled by air conditioning with a considerable level of energy expenditure. The same also applies to means of transport, such as passenger vehicles, trucks, buses, trains, aircraft and the like.

Current methods of thermal insulation (specifically for minimizing heating), especially for shielding thermal radiation in the wavelength range between 800 nm and 2000 nm, are based on the absorption of the radiation by appropriate dyes or pigments. However, the energy absorbed is for the most part released to the object or space to be insulated as a result of thermal conduction (thermal dissipation).

Especially in the case of glazing, it is known to use materials which substantially reflect thermal radiation. For this purpose, the broadband absorbers or reflectors used are in many cases specific dyes or pigments, but also graphite or gold.

The dyes used here are, for example, naphthalocyanines with broadband absorption in the infrared (IR) or else laked polymethine dyes. One disadvantage is that the radiative energy absorbed is converted to thermal energy, which dissipates through thermal conduction.

Graphite, gold, silver or indium tin oxide (ITO), which are also used as absorbers or reflectors for IR radiation, have comparable disadvantages. Here, especially in the visible region of the spectrum, there is a sometimes significant intrinsic color. Only through very precise and therefore complicated production of extremely thin layers is sufficiently homogeneous high transmission in the visible wavelength range ensured. Such metal layers are generally applied by vapor deposition processes such as chemical vapor deposition or physical vapor deposition, which are very costly and inconvenient. A further disadvantage is that such layers often reflect over a very wide range of the electromagnetic spectrum, for example also in the microwave and/or radio wave range, which is unacceptable for many applications which require good transmission in these ranges.

It is likewise known that cholesteric liquid-crystalline substances can reflect in the IR region of the electromagnetic spectrum. Cholesteric (chiral nematic) liquid crystals have already been known for some time. The first example of such a material was found by the Austrian botanist F. Reinitzer (Monatshefte Chemie, 9 (1888), 421). The prerequisite for the occurrence of cholesteric phases is chirality. The chiral molecular moiety may either already be present in the liquid-crystalline molecule itself or may be added to the nematic phase as a dopant, which induces the chiral nematic phase. The chiral nematic phase has exceptional optical properties: high optical rotation and pronounced circular dichroism, which arises through selective reflection of circular-polarized light within the chiral nematic layer. This has the consequence that not more than 50% of the incident light with the reflection wavelength is reflected. The rest passes through without interaction with the medium. The sense of the reflected light is determined by the sense of the helix: a right-handed helix reflects right-handed circular-polarized light, a left-handed helix left-handed circular-polarized light. Altering the concentration of a chiral dopant allows the pitch and hence the wavelength range of selectively reflected light of a chiral nematic layer to be varied. There is a direct relationship here between the reciprocal of the pitch p observed and the concentration of the chiral compound (x_{ch}):

1/p=HTP x_{ch}

HTP stands for helical twisting power and indicates the twisting power (different according to the compound) of the chiral dopant.

U.S. Pat. No. 4,637,896 discloses cholesteric liquid-crystalline compounds based on cholesterol derivatives and photopolymerized cholesteric coatings which comprise them in copolymerized form. The majority of the cholesteric films described have reflection maxima in the visible wavelength range. However, two examples of colorless films are also specified, whose reflection maxima are at 950 and 1260 nm respectively. However, owing to the narrow reflection range, these films are unsuitable as a thermal insulation coating.

U.S. Pat. No. 5,629,055 discloses solid cholesteric films based on cellulose. The films are obtainable from colloid suspensions of cellulose crystallites, the colloid suspensions being prepared by acidic hydrolysis of crystalline cellulose. The solid films have cholesteric properties and their reflection wavelength is said to be adjustable over the entire spectral range from infrared to ultraviolet. The materials described are proposed especially as means of visual authentication, since printing or photocopying techniques cannot reproduce the cholesteric effect.

WO 2006/128091 describes multilayer laminates which, as well as at least one polymer film with a particular modulus of elasticity, also comprise one or more layers of twisted nematic liquid crystals. These are said to reflect radiation in the IR wavelength range, as a result of which the laminate has thermally insulating action.

However, the thermally insulating action is still unsatisfactory.

It was an object of the present invention to provide easy-to-produce thermally insulating films and laminates which reflect electromagnetic radiation with a wavelength in the infrared (IR radiation), especially IR radiation in a wavelength range from 751 to about 2000 nm, and which, if desired, are simultaneously virtually completely transparent in the visible range of the electromagnetic spectrum. In addition, thermally insulating films and laminates should, if desired, be able to transmit or reflect, in a controlled manner, particular wavelengths or wavelength ranges in other regions of the electromagnetic spectrum.

The object is achieved by a thermally insulating film comprising
(a) at least one liquid-crystalline layer in hardened form, which reflects in the wavelength range of the infrared and is obtainable by hardening
(a.1) a composition comprising at least one achiral nematic polymerizable monomer and at least one chiral polymerizable monomer; or
(a.2) a composition comprising at least one cholesteric polymerizable monomer; or
(a.3) a composition comprising at least one cholesteric crosslinkable polymer; or
(a.4) a composition comprising at least one cholesteric polymer in a polymerizable diluent; or
(a.5) a mixture of at least two of these compositions;
(b) optionally at least one carrier film;
(c) optionally at least one alignment layer which is in contact with at least one liquid-crystalline layer; p1 (d) optionally at least one λ/2 film;
(e) optionally at least one adhesive layer, protective layer and/or release layer.

The remarks which follow regarding preferred features of the inventive film, especially of components a, b, c, d and e and also of further optional components, of the inventive laminates, of the process according to the invention and of the inventive pigments apply both taken alone and particularly in combination with one another.

In the context of the present invention, the term “thermally insulating” means especially shielding of thermal radiation.

In the context of the present invention, the term “liquid-crystalline” is used essentially synonymously with “cholesteric”, unless evident otherwise from the particular context.

In the context of the present invention, a film is understood to mean a self-supporting flat structure, i.e. a structure whose thickness is not more than 5 mm, preferably not more than 3 mm, more preferably not more than 1.5 mm and especially not more than 1 mm, the thickness of which, moreover, is negligibly small in relation to length and width, for example is smaller than the next greatest dimension by a factor of at least 20 or at least 50 or at least 100 or at least 500, and which is simultaneously also flexible. The flexibility is so great that the film can be rolled up without fracturing.

The wavelength range (spectral range) of the infrared (IR radiation) is generally understood to mean the spectral range of electromagnetic radiation with a wavelength of from >750 nm (e.g. 751 nm) to about 1 mm.

The inventive film preferably reflects in the wavelength range of the near infrared (NIR), i.e. in the spectral range with a wavelength of from >750 nm (e.g. 751 nm) to about 2000 nm. Reflection close to the visible spectrum frequently leads to a reddish film, which is undesired in some applications. The inventive film therefore more preferably reflects in a wavelength range from 850 to 2000 nm, even more preferably from 900 to 2000 nm and especially from 950 to 2000 nm. In this range, the reflection is preferably not in the form of a sharp peak, but rather in the form of a very wide reflection band. The film preferably possesses two or more reflection bands, for example 2, 3 or 4 reflection bands, of which preferably at least two, for example 2, 3 or 4, overlap partially with the neighboring band(s). The partial overlapping achieves a high level of reflection in the wavelength range of the reflection bands.

The inventive film, in the wavelength range from 751 to 2000 nm, preferably reflects at least 10%, more preferably at least 20%, even more preferably at least 30%, particularly preferably at least 40% and especially at least 45% of the incident radiation.

At the same time, the inventive film, in the visible wavelength range, i.e. from about 350 to 750 nm, has a transmission of preferably at least 80%, more preferably at least 95%, of the incident radiation.

The film may, however, also be configured if desired for particular applications such that the transmission in the visible wavelength range is lower. Thus, a preferred embodiment of the invention relates to a film which, as described above, reflects IR radiation and also reflects electromagnetic radiation in the visible wavelength range (i.e. from about 350 to 750 nm), preferably in the range from 550 to 750 nm, especially from 600 to 700 nm. More specifically, the inventive film in this preferred embodiment has one or more, for example 1, 2 or 3, preferably 1, reflection band(s) with a maximum in the visible wavelength range, preferably in the range from 550 to 750 nm and especially in the range from 600 to 700 nm.

In this case, the invention relates preferably to a thermally insulating film comprising
(a) at least one liquid-crystalline layer in hardened form, which reflects in the wavelength range of the infrared and is obtainable by hardening
   (a.1) a composition comprising at least one achiral nematic polymerizable monomer and at least one chiral polymerizable monomer; or
   (a.2) a composition comprising at least one cholesteric polymerizable monomer; or
   (a.3) a composition comprising at least one cholesteric crosslinkable polymer; or
   (a.4) a composition comprising at least one cholesteric polymer in a polymerizable diluent; or
   (a.5) a mixture of at least two of these compositions;
(b) optionally at least one carrier film;
(c) optionally at least one alignment layer which is in contact with at least one liquid-crystalline layer;
(d) optionally at least one λ/2 film;
(e) optionally at least one adhesive layer, protective layer and/or release layer;
(f) at least one liquid-crystalline layer in hardened form, which reflects in the wavelength range of the visible, preferably in the range from 550 to 750 nm, especially from 600 to 700 nm, and which is obtainable by hardening
   (f.1) a composition comprising at least one achiral nematic polymerizable monomer and at least one chiral polymerizable monomer; or
   (f.2) a composition comprising at least one cholesteric polymerizable monomer; or
   (f.3) a composition comprising at least one cholesteric crosslinkable polymer; or
   (f.4) a composition comprising at least one cholesteric polymer in a polymerizable diluent; or
   (f.5) a mixture of at least two of these compositions.

In a preferred embodiment, the inventive film is alternatively or additionally configured such that it has, over the entire radio wave range or in particular wavelength ranges for radio waves, a transmission of preferably at least 80%, more preferably at least 95%, of the incident radiation. To this end, the inventive film in this embodiment is essentially metal-free, i.e. it comprises not more than 0.5% by weight, preferably not more than 0.1% by weight and especially not more than 0.05% by weight, based on the total weight of the film, of metallic constituents which can disrupt the transmission of radio waves. Very substantially complete transmission of radio waves is, for example, important in order to be able to send and receive radio waves, for example for cell phones or W-LAN. Moreover, high transmissibility of radio waves is important, for example, for rain sensors in automobiles or buildings, which trigger and control the switching on and off and the wiper speed of the windshield wipers of automobiles, and the closure and opening of building windows according to the weather conditions. Equally, the inventive film, in a preferred embodiment, is additionally configured such that, over the entire microwave range or in particular wavelength regions for microwaves, it has a transmission of preferably at least 80%, more preferably at least 95%, of the incident radiation.

In the context of the present invention, crosslinking is understood to mean the covalent linkage of polymeric compounds, and polymerization to mean the covalent linkage of monomeric compounds to give polymers. Hardening is understood to mean crosslinking, polymerization or the freezing of the cholesteric phase. Hardening fixes the homogeneous alignment of the cholesteric molecules in the liquid-crystalline layer.

Preferably, at least one achiral nematic polymerizable monomer of the composition (a.1) is polyfunctionally and especially difunctionally polymerizable.

Preferred achiral nematic difunctionally polymerizable monomers correspond to the general formula I

Z¹—(Y¹-A¹)ᵥ-Y²-M-Y³-(A²-Y⁴)_{w}—Z² (I)

in which
Z¹, Z² are identical or different reactive groups through which polymerization can be effected, or radicals which comprise such reactive groups, the reactive groups preferably being selected from C═C double bonds, C═C triple bonds, oxirane, thiirane, azirane, cyanate, thiocyanate, isocyanate, carboxylic acid, hydroxyl or amino groups, and preferably from C═C double bonds (these may, for example, be —CH═CH₂ or —C(CH₃)═CH₂ or else —CH═CH(CH₃), preference being given to the first two mentioned);
Y¹, Y², Y³, Y⁴ are each independently a chemical bond, —O—, —S—, —CO—O—, —O—CO—, —O—CO—O—, —CO—S—, —S—CO—, —CO—N(R^{a})—, —N(R³)—CO—, —N(R^{a})—CO—O—, —O—CO—N(R^{a})—, —N(R^{a})—CO—N(R^{a})—, —CH₂—O—, —O—CH₂—, preferably —CO—O—, —O—CO— or —O—CO—O—,
where R^{a} is hydrogen or C₁-C₄-alkyl;
A¹, A² are identical or different spacers which are selected from linear C₂-C₃₀-alkylene groups, preferably C₂-C₁₂-alkylene groups, which may be interrupted by oxygen, sulfur and/or optionally monosubstituted nitrogen, where these interrupting groups must not be adjacent; where suitable amine substituents comprise C₁-C₄-alkyl groups, where the alkylene chains may be substituted by fluorine, chlorine, bromine, cyano, methyl or ethyl; and where A¹ and A² are more preferably —(CH₂)ₙ— where n=from 2 to 6;
v and w are each independently 0, 1 or 2;
M is a mesogenic group, preferably a mesogenic group of the general formula II:

(T¹-Y⁵)_{y}-T² (II)

in which
each T¹ is independently a divalent alicyclic, saturated or partially unsaturated heterocyclic, aromatic or heteroaromatic radical;
   T² is independently as defined for T¹;
   Y⁵ represents identical or different bridging members —CO—O—, —O—CO—, —CH₂—O—, —O—CH₂—, —CO—S—, —S—CO—, —CH₂—S—, —S—CH₂, —CH═N—, —N═CH—, —CH═N—N═CH—, —C≡C—, —CH═CH—, —C(CH₃)═CH₂, —CH═CH(CH₃)— or a direct bond and is preferably —CO—O— or —O—CO—, and
   y is an integer from 0 to 3, preferably 0, 1 or 2, in particular 1 or 2 and especially 2.
T² is preferably an aromatic radical and more preferably a phenyl radical. T² is especially a radical of the formula

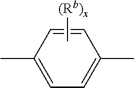

in which
R^{b} is fluorine, chlorine, bromine, C₁-C₂₀-alkyl, C₁-C₁₀-alkoxy, C₁-C₁₀-alkylcarbonyl, C₁-C₁₀-alkylcarbonyloxy, C₁-C₁₀-alkoxycarbonyl, hydroxyl, nitro, CHO or CN, preferably chlorine, bromine, C₁-C₄-alkyl or C₁-C₄-alkoxycarbonyl, and especially methyl or methoxycarbonyl; and
x is 0, 1, 2, 3 or 4, preferably 0, 1 or 2, more preferably 0 or 1 and especially 1.

Each T¹ is independently preferably an aromatic radical, more preferably phenyl or naphthyl and especially 1,4-bonded phenyl or 2,6-bonded naphthyl.

Y⁵ is preferably —CO—O— or —O—CO—.

y is preferably 2.

Particularly preferred mesogenic groups M have the following structures:

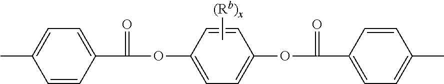

in which R^{b} and x each have one of the general or preferred definitions specified above, where R^{b} is especially methyl and x is 1, or

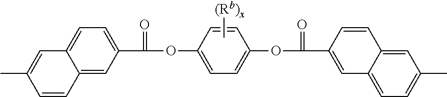

in which R^{b} and x have one of the general or preferred definitions specified above, where R^{b} is especially methoxycarbonyl and x is 1.

In a particularly preferred embodiment, the achiral nematic difunctionally polymerizable monomers are selected from compounds of the following formulae I.a and I.b

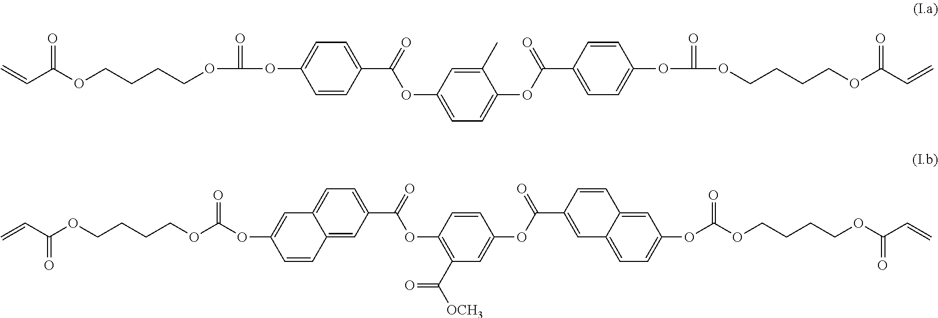

and mixtures thereof.

However, the composition (a.1) may also comprise a monofunctionally polymerizable achiral nematic monomer. This preferably has the general formula (IIIa) and/or (IIIb):

A³-Y²-M-Y³-(A²-Y⁴)_{w}—Z² (IIIa)

Z¹—(Y¹-A¹)ᵥ-Y²-M-Y³-A³ (IIIb)

in which Z¹, A¹, Y¹, Y², Y³, Y⁴, v, w and M are each independently as defined or preferably for formula (I); and
A³ is a linear C₁-C₃₀-alkyl group, preferably a linear C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl group may be substituted by fluorine, chlorine, bromine, cyano, methyl or ethyl, or is CN or —N═C═S—.

A³ is preferably linear C₂-C₈-alkyl or CN and especially linear C₄-C₈-alkyl or CN.

Y¹, Y², Y³, Y⁴ and Y⁵ are each independently preferably —O—CO—, —CO—O—, —O—CO—O— or a C—C-triple bond.

Z¹ is preferably a C—C-double bond (preferably —CH═CH₂ or —C(CH₃)═CH₂).

M is preferably a mesogenic group of the general formula II. T¹ and T² are preferably each independently an aromatic group, more preferably phenyl or naphthyl which may bear 0, 1, 2, 3 or 4 R^{b} radicals, where R^{b} has one of the general or preferred definitions specified above, especially 1,4-bonded phenyl or 2,6-bonded naphthyl which may bear 0, 1, 2, 3 or 4 R^{b} radicals, where R^{b} has one of the general or preferred definitions specified above, and especially unsubstituted 1,4-bonded phenyl or unsubstituted 2,6-bonded naphthyl. y is preferably 0 or 1.

Particularly preferred monofunctionally polymerizable achiral nematic monomers are selected from the following structures:

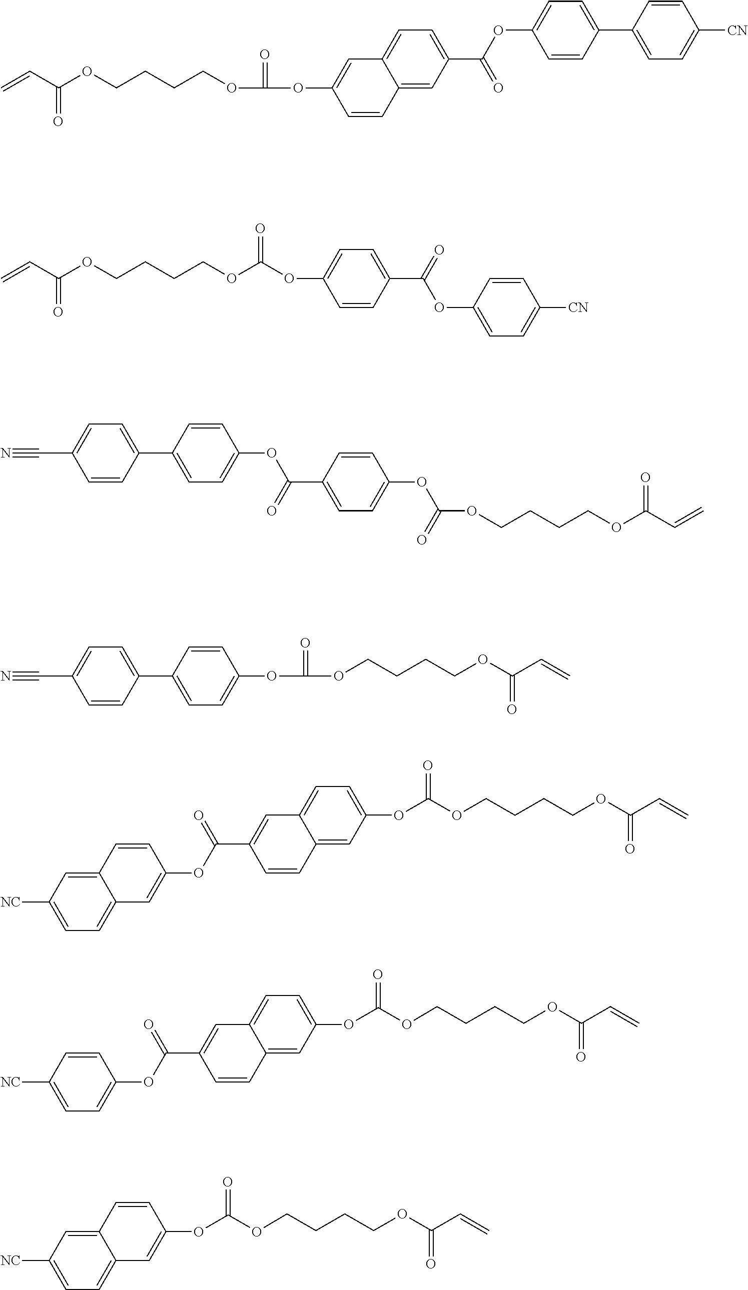

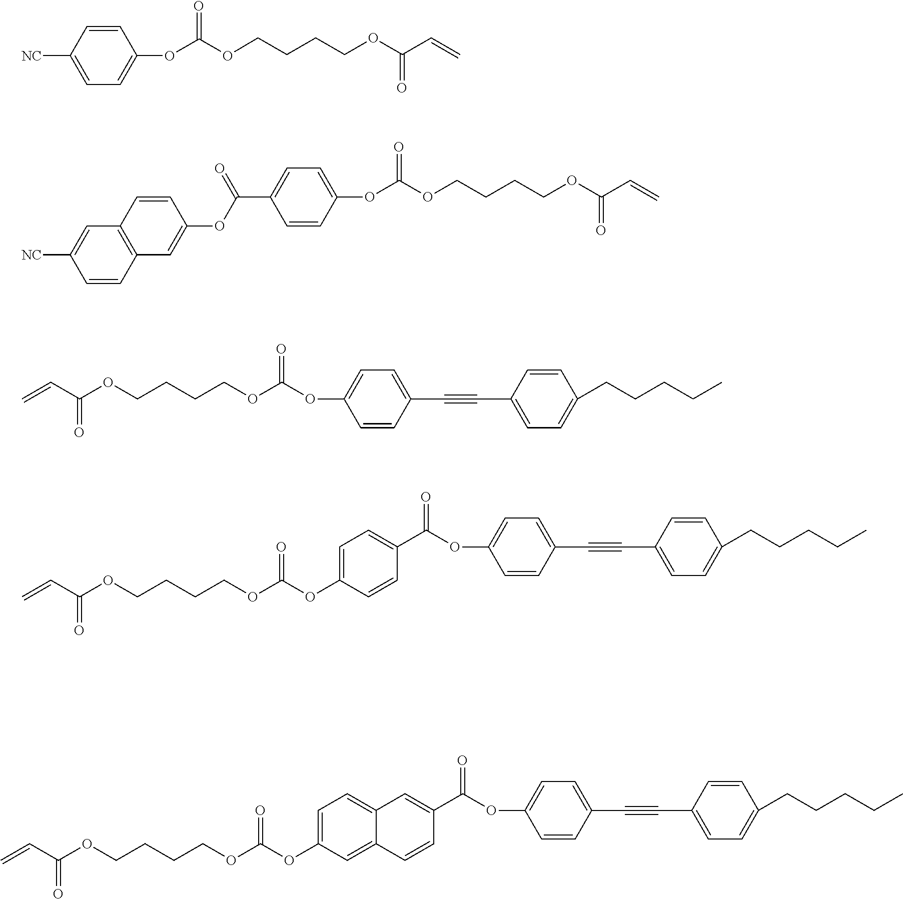

The at least one achiral nematic polymerizable monomer of the composition (a.1) comprises preferably
(i) at least one difunctionally polymerizable achiral nematic monomer of the formula (I), preferably one or two difunctionally polymerizable achiral nematic monomers of the formula (I); and
(ii) optionally at least one monofunctionally polymerizable achiral nematic monomer of the formula (IIIa) and/or (IIIb).

When the composition (a.1) comprises one or more monofunctionally polymerizable monomers, they are preferably present in the composition in a total amount of not more than 40% by weight, more preferably of not more than 20% by weight, even more preferably of not more than 10% by weight and especially of not more than 5% by weight, based on the total weight of the poly- and monofunctionally polymerizable achiral nematic monomers.

In a specific embodiment, the composition (a.1) does not comprise any monofunctionally polymerizable achiral nematic monomers, but rather only at least one, preferably one or two, polyfunctionally, especially difunctionally, polymerizable achiral nematic monomer(s).

The chiral polymerizable monomer of the composition (a.1) corresponds preferably to the formula IV

[(Z¹—Y¹)ₒ-A⁴-Y²-M-Y³]ₙX[Y³-M-Y²A⁵-(Y¹—Z¹)ₚ]ₘ (IV)

where
Z¹, Y¹, Y², Y³ and M each have one of the general or preferred definitions specified above for formula (I)
o, p are each 0 or 1, where o and p must not both be 0,
A⁴ and A⁵ are the same or different; and
A⁴ is as defined for A¹ when o=1; or,
when o=0, is a linear C₁-C₃₀-alkyl group, preferably C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl groups may be substituted by fluorine, chlorine, bromine, cyano, methyl or ethyl, and where A⁴ more preferably represents CH₃(CH₂)_{I} groups where I=from 1 to 7;
A⁵ is as defined for A¹ when p=1; or,
when p=0, is a linear C₁-C₃₀-alkyl group, preferably C₁-C₁₂-alkyl group, which may be interrupted by oxygen, sulfur and/or optionally monosubstituted nitrogen, where these interrupting groups must not be adjacent; where suitable amine substituents comprise C₁-C₄-alkyl groups, where the alkyl groups may be substituted by fluorine, chlorine, bromine, cyano, methyl or ethyl, and where A⁵ more preferably represents CH₃(CH₂)_{I} groups where I=from 1 to 7;
n, m are each 0, 1 or 2, where the sum of n+m is 1 or 2, preferably 2; and
X is a chiral radical.

The mesogenic M groups preferably have the formula II

(T¹-Y⁵)_{y}-T² (II)

in which T¹, T² and Y⁵ each have one of the general or preferred definitions specified above. y has one of the general definitions specified above, but is preferably 0 or 1.

T² is preferably an aromatic radical and more preferably a phenyl radical. T² is especially a radical of the formula

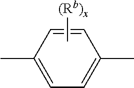

in which
R^{b} is fluorine, chlorine, bromine, C₁-C₂₀-alkyl, C₁-C₁₀-alkoxy, C₁-C₁₀-alkylcarbonyl, C₁-C₁₀-alkylcarbonyloxy, C₁-C₁₀-alkoxycarbonyl, hydroxyl, nitro, CHO or CN, preferably chlorine, bromine, C₁-C₄-alkyl or C₁-C₄-alkoxycarbonyl, and especially methyl or methoxycarbonyl; and
x is 0, 1, 2, 3 or 4, preferably 0, 1 or 2, more preferably 0 or 1 and especially 0.

Each T¹ independently is preferably an aromatic radical, more preferably phenyl or naphthyl, even more preferably 1,4-bonded phenyl or 2,6-bonded naphthyl and especially unsubstituted 1,4-bonded phenyl or unsubstituted 2,6-bonded naphthyl.
Y⁵ is preferably —CO—O— or —O—CO—.
y is preferably 0 or 1.

Among the chiral X radicals of the compounds of the general formula IV, for reasons including easier availability, preference is given especially to those which derive from sugars, dinaphthyl or diphenyl derivates and optically active glycols, alcohols or amino acids. Among the sugars, especially pentoses and hexoses and derivatives derived therefrom should be mentioned.

Examples of X radicals are the following structures, where the terminal dashes are in each case the free valences.

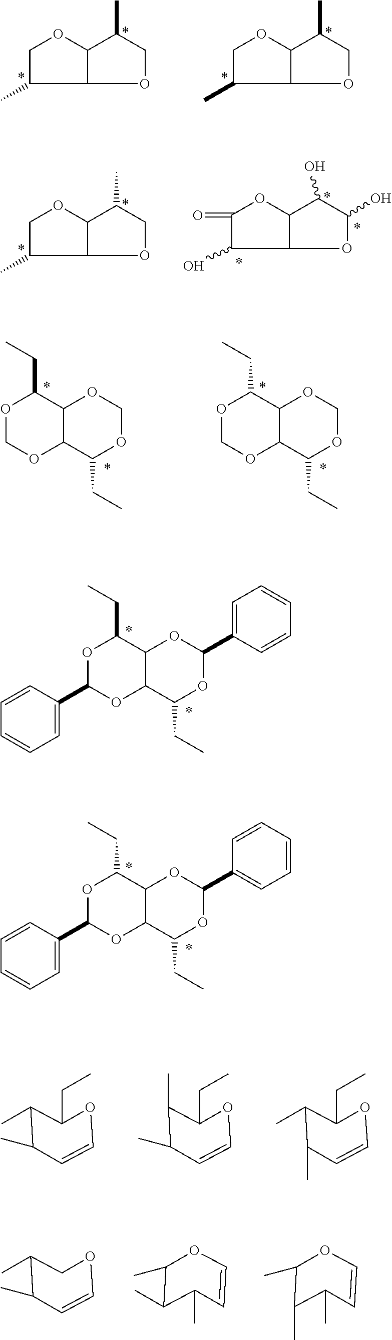

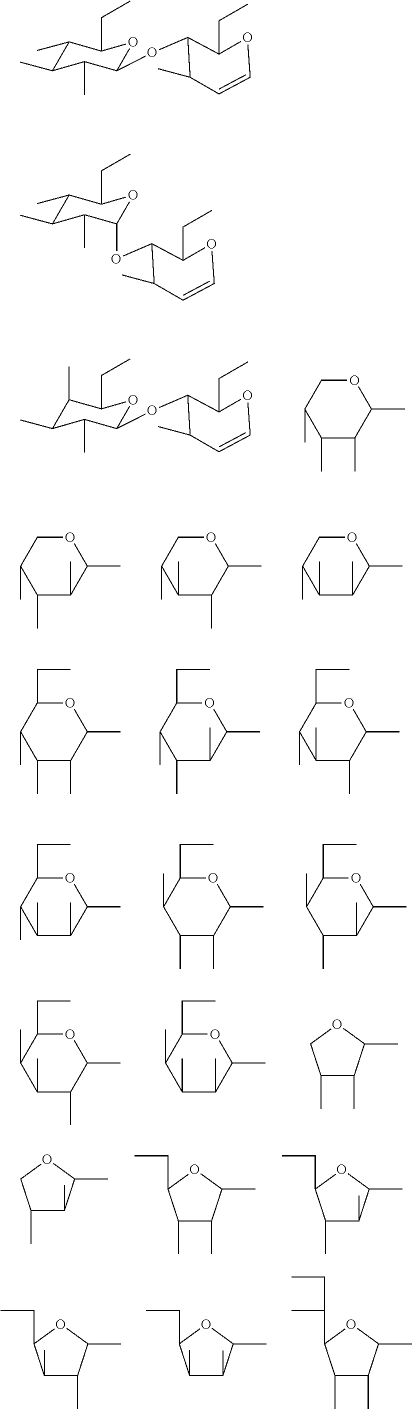

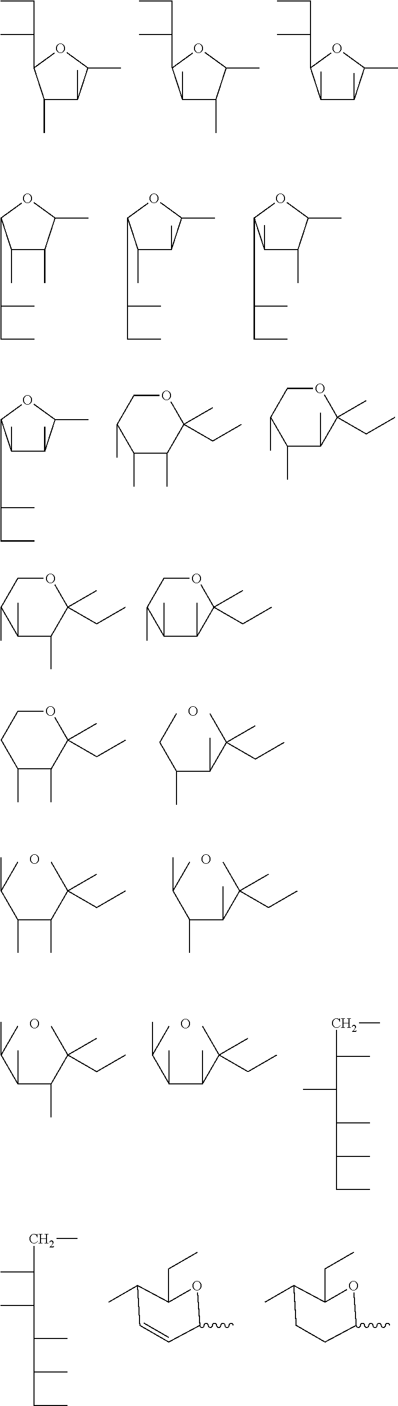

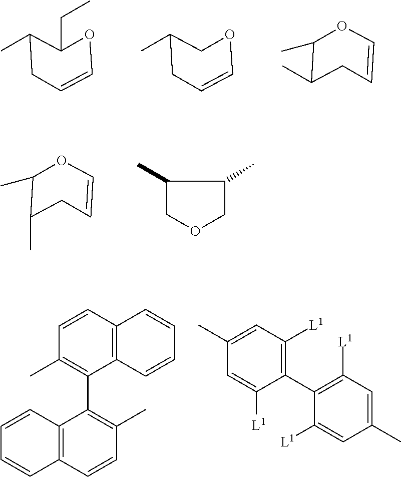

where
L¹ is C₁-C₄-alkyl, C₁-C₄-alkoxy, halogen, COOR^{c}, OCOR^{c} or NHCOR^{c}, and R^{c} is C₁-C₄-alkyl or hydrogen.

Particular preference is given to

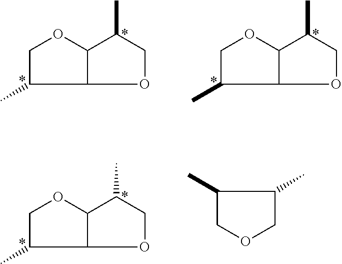

Additionally suitable are also chiral groups which have the following structures:

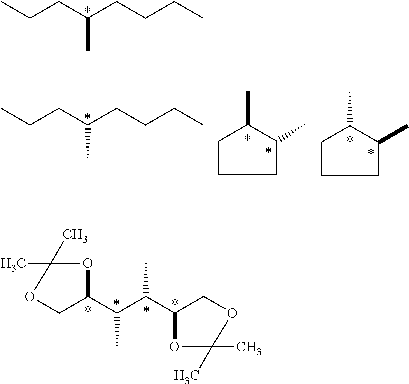

In a particularly preferred embodiment, the chiral polymerizable monomer is selected from the following structural formulae

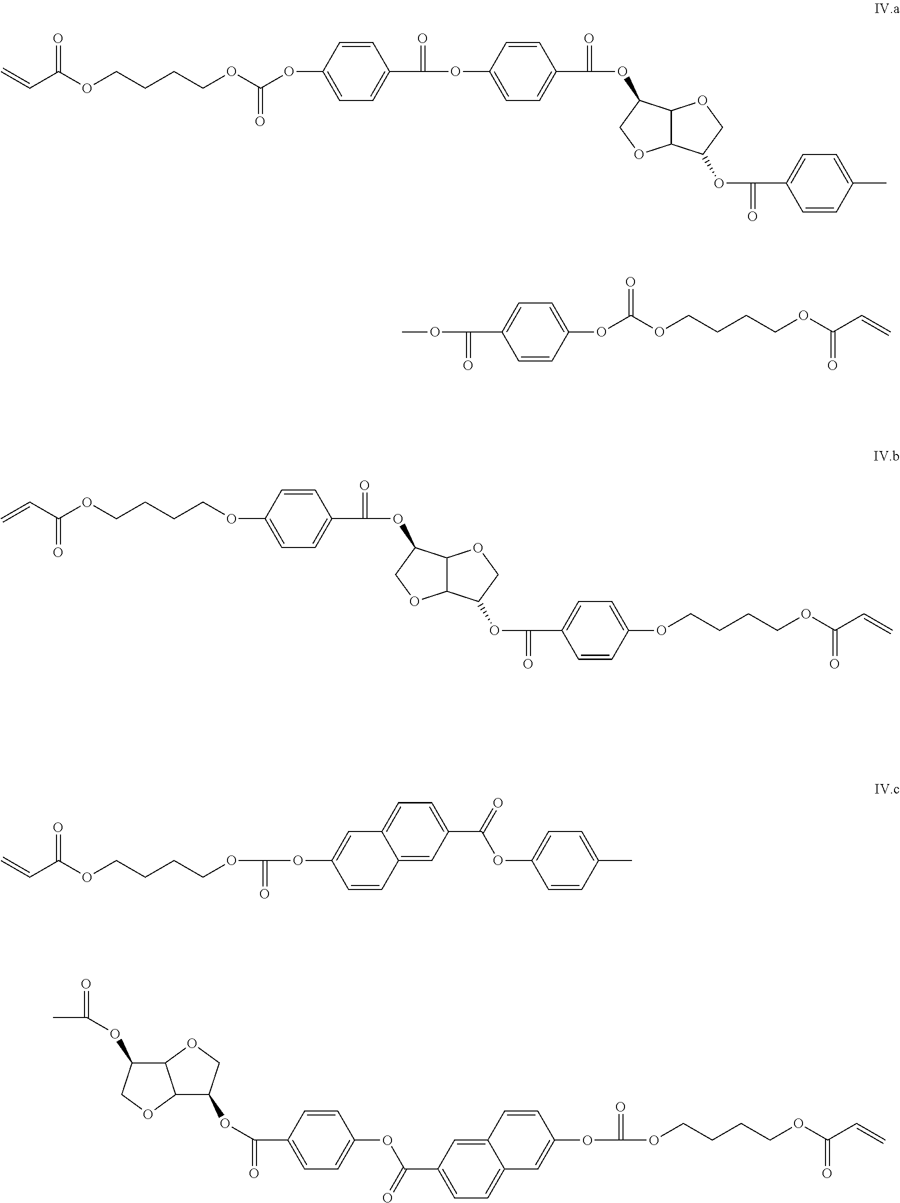

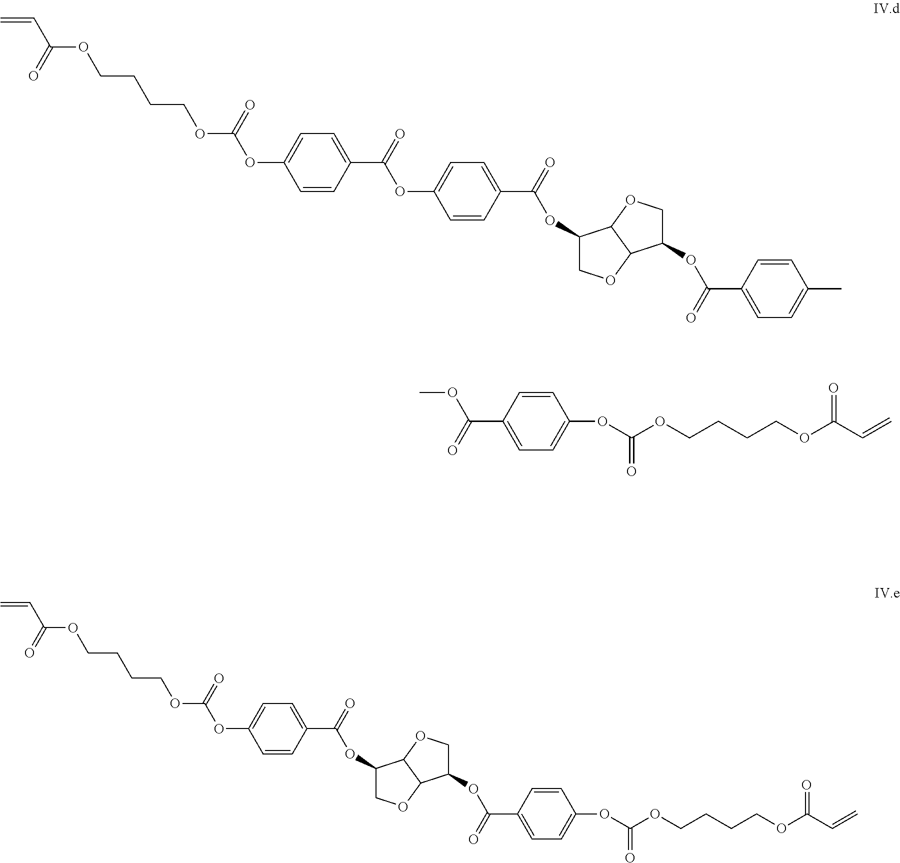

Among these, preference is given to the compounds of the formulae IV.a, IV.b and IV.c and particular preference to the compounds of the formulae IV.a and IV.c. Especially preferred is the compound of the formula IV.c.

At least one liquid-crystalline layer (a) of the inventive film is preferably formed from a composition (a.1) in which the chiral polymerizable compound used is the compound IV.c.

The quantitative ratio of achiral nematic monomer to chiral monomer in the inventive mixture (a.1) is selected such that the polymer formed from these monomers, after alignment, has a pitch of the helical superstructure which corresponds to a wavelength of the IR spectral region preferably in the range from 751 to 2000 nm. The quantitative ratio depends on the type of nematic and chiral monomers and has to be determined from individual case to individual case.

However, it is generally the case that, given a particular nematic monomer and a particular chiral monomer with increasing concentration of the chiral component compared to the nematic component, the maximum of the reflection band shifts to shorter wavelengths.

For example, for the production of liquid-crystalline, IR-reflective layers (a) which have essentially no intrinsic color, i.e. have a transmission in the visible wavelength range of at least 80%, preferably at least 85%, among compounds Lb and IV.a, the compound IV.a is used in an amount of preferably at most 4.0% by weight, for example 1.0 to 4.0% by weight or 1.5 to 4.0% by weight or 2.0 to 4.0% by weight, more preferably at most 3.5% by weight, for example 1.0 to 3.5% by weight or 1.5 to 3.5% by weight or 2.0 to 3.5% by weight, and especially at most 3.3% by weight, for example 1.0 to 3.3% by weight or 1.5 to 3.3% by weight or 2.0 to 3.3% by weight, based on the weight of the compound I.b. In the case of the combination of compounds I.a and IV.a, for the same purpose, the compound IV.a is used in an amount of preferably at most 3.2% by weight, for example 1.0 to 3.2% by weight or 1.5 to 3.2% by weight or 2.0 to 3.2% by weight, more preferably at most 3.0% by weight, for example 1.0 to 3.0% by weight or 1.5 to 3.0% by weight or 2.0 to 3.0% by weight, and especially at most 2.9% by weight, for example 1.0 to 2.9% by weight or 1.5 to 2.9% by weight or 2.0 to 2.9% by weight, based on the weight of the compound I.a. In the case of the combination of compounds of I.b and IV.c, for the same purpose, the compound IV.c is used in an amount of preferably at most 11% by weight, for example 1.0 to 11% by weight or 1.5 to 11% by weight or 2.0 to 11% by weight, more preferably at most 10.0% by weight, for example 1.0 to 10.0% by weight or 1.5 to 10.0% by weight or 2.0 to 10.0% by weight, even more preferably at most 9.0% by weight, for example 1.0 to 9.0% by weight or 1.5 to 9.0% by weight or 2.0 to 9.0% by weight, and especially at most 8.5% by weight, for example 1.0 to 8.5% by weight or 1.5 to 8.5% by weight or 2.0 to 8.5% by weight, based on the weight of the compound I.b. In the case of the combination of compounds I.a and IV.c, for the same purpose, the compound IV.c in used in an amount of preferably at most 12% by weight, for example 1.0 to 12% by weight or 1.5 to 12% by weight or 2.0 to 12% by weight, more preferably at most 11.5% by weight, for example 1.0 to 11.5% by weight or 1.5 to 11.5% by weight or 2.0 to 11.5% by weight, and especially at most 11.0% by weight, for example 1.0 to 11.0% by weight or 1.5 to 11.0% by weight or 2.0 to 11.0% by weight, based on the weight of the compound I.a.

For the production of liquid-crystalline layers with a reflection band in the visible wavelength range, correspondingly greater amounts of chiral compound are used (see also remarks below regarding layer (f)). For example, in the case of a combination of the compounds I.b and IV.c, the compound IV.c is used in an amount of preferably >11 to 15% by weight, more preferably 11.1 to 14% by weight and especially 11.2 to 13.5% by weight, based on the weight of the compound I.b.

Alternatively, the layer (a) may also comprise at least one cholesteric polymerizable monomer of the composition (a.2) in hardened form.

Preferred monomers of group (a.2) are described in DE-A 19602848, which is hereby fully incorporated by reference. More particularly, the monomers comprise at least one cholesteric polymerizable monomer of the formula XIII

(Z¹—Y¹-A¹-Y²-M¹-Y³)ₙX (XIII).

The variables are as defined for the monomers of group (a.1). The preferred embodiments apply correspondingly.

Alternatively, the layer (a) may comprise at least one cholesterically crosslinkable polymer of the composition (a.3).

Preferred polymers of group (a.3) are described in WO 2008/012292 and in the literature cited therein, which is hereby fully incorporated by reference.

Alternatively, the layer (a) may also comprise a cholesteric polymer in a polymerizable diluent (composition (a.4)).

Preferred polymers and diluents of group (a.3) are described in WO 2008/012292 and in the literature cited therein, which is hereby fully incorporated by reference. Preferred polymers of group (a.4) are, for example, crosslinkable cholesteric copolyisocyanates as described in US-A-08 834 745, which is hereby fully incorporated by reference.

The layer (a) preferably comprises the composition (a.1) in hardened form. With regard to preferred configurations of the composition (a.1), reference is made to the statements above. The composition (a.1) preferably comprises the nematic polymerizable monomer in an amount of from 80 to 99.5% by weight and the chiral polymerizable monomer in an amount of from 0.5 to 20% by weight, based in each case on the total weight of the composition (a.1). The proportion of chiral-nematic monomer determines the spectral region in which the composition (a.1) reflects after hardening and alignment. The desired reflection range can be established with the aid of simple preliminary tests as a function of the individual nematic and chiral components and their particular concentrations. The composition (a.1) more preferably comprises the nematic polymerizable monomer in an amount of from 85 to 99.5% by weight, more preferably from 85 to 99% by weight and especially from 90 to 98% by weight, and the chiral polymerizable monomer in an amount of from 0.5 to 15% by weight, more preferably from 1 to 15% by weight and especially from 2 to 10% by weight, based in each case on the total weight of the nematic polymerizable monomers and of the chiral polymerizable monomers in the composition (a.1). With regard to suitable and preferred ratios for monomers used with preference, reference is made to the above remarks.

If desired, the compositions (a.1), (a.2), (a.3), (a.4) and (a.5), as well as the components already mentioned which are responsible for the reflection behavior, may comprise further mixture constituents which are preferably selected from
at least one component C which is in turn selected from

(C.1) photoinitiators;

(C.2) reactive diluents which comprise photopolymerizable groups;

(C.3) diluents;

(C.4) defoamers and deaerating agents;

(C.5) lubricants and leveling agents;

(C.6) thermally curing and/or radiation-curing auxiliaries;

(C.7) substrate wetting auxiliaries;

(C.8) wetting and dispersing auxiliaries;

(C.9) hydrophobizing agents;

(C.10) adhesion promoters; and

(C.11) auxiliaries for improving scratch resistance;
at least one component D which is in turn selected from

(D.1) dyes; and

(D.2) pigments;
at least one component E which is in turn selected from light, heat and oxidation stabilizers; and
at least one component F which is in turn selected from IR-absorbing compounds.

When the compositions (a.1), (a.2), (a.3), (a.4) or (a.5) are to be polymerized photochemically, they may comprise commercial photoinitiators. For curing by electron beams, they are not required. Suitable photoinitiators are, for example, isobutyl benzoin ether, 2,4,6-trimethylbenzoyldiphenylphosphine oxide, 1-hydroxycyclohexyl phenyl ketone, 2-benzyl-2-dimethylamino-1-(4-morpholinophenyl)furan-1-one, mixtures of benzophenone and 1-hydroxycyclohexyl phenyl ketone, 2,2-dimethoxy-2-phenylacetophenone, perfluorinated diphenyltitanocenes, 2-methyl-1-(4-[methylthio]-phenyl)-2-(4-morpholinyl)-1-propanone, 2-hydroxy-2-methyl-1-phenylpropan-1-one, 4-(2-hydroxyethoxy)phenyl 2-hydroxy-2-propyl ketone, 2,2-diethoxyacetophenone, 4-benzoyl-4′-methyldiphenyl sulfide, ethyl 4-(dimethylamino)benzoate, mixtures of 2-isopropylthioxanthone and 4-isopropylthioxanthone, 2-(dimethylamino)ethyl benzoate, d,l-camphorquinone, ethyl-d,l-camphorquinone, mixtures of benzophenone and 4-methylbenzophenone, benzophenone, 4,4′-bis(dimethylamine)benzophenone, (η⁵-cyclopentadienyl) (η⁶-isopropylphenyl)iron(II) hexafluorophosphate, triphenylsulfonium hexafluorophosphate or mixtures of triphenylsulfonium salts, and butanediol diacrylate, dipropylene glycol diacrylate, hexanediol diacrylate, 4-(1,1-dimethylethyl)cyclohexyl acrylate, trimethylolpropane triacrylate and tripropylene glycol diacrylate.

Suitable commercial photoinitiators (C.1) are, for example, those which are commercially available under the brand names Lucirin®, Irgacure® and Darocure®. Preference is given to using the initiators Lucirin® TPO, Lucirin® TPO-L, Irgacure® Oxe 01, Irgacure® Oxe 02, Irgacure® 1300, Irgacure® 184, Irgacure® 369, Irgacure® 907 or Darocure® 173, and particular preference to using the initiators Lucirin® TPO, Lucirin® TPO-L, Irgacure® Oxe 01, Irgacure® Oxe 02, Irgacure® 1300 or Irgacure® 907.

The photoinitiators are used typically in a proportion of from about 0.1 to 5.0% by weight based on the total weight of the liquid-crystalline mixture. Especially when the hardening is performed under inert gas atmosphere, it is possible to use significantly smaller amounts of photoinitiators. In this case, the photoinitiators are used in a proportion of from about 0.1 to 1.0% by weight, preferably from 0.2 to 0.6% by weight, based on the total weight of the liquid-crystalline mixture.

Reactive diluents (C.2) are used, for example, as polymerizable diluents in component (a.4); they are then necessarily part of the inventive mixture.

The reactive diluents used are not only those substances which are referred to as reactive diluents in the actual sense (group C.2.1), but also auxiliary compounds which comprise one or more complementary reactive units, for example hydroxyl or amino groups, through which a reaction with the polymerizable units of the liquid-crystalline compounds can be effected (group C.2.2).

The substances of group (C.2.1) which are typically capable of photopolymerization include, for example, mono-, bi- or polyfunctional compounds having at least one olefinic double bond. Examples thereof are vinyl esters of carboxylic acids, for example of lauric acid, myristic acid, palmitic acid or stearic acid, or of dicarboxylic acids, for example of succinic acid and adipic acid, allyl or vinyl ethers or methacrylic or acrylic esters of monofunctional alcohols, for example of lauryl alcohol, myristyl alcohol, palmityl alcohol or stearyl alcohol, or diallyl or divinyl ethers of bifunctional alcohols, for example of ethylene glycol and of butane-1,4-diol.

Further useful examples are methacrylic or acrylic esters of polyfunctional alcohols, especially those which, as well as the hydroxyl groups, comprise no further functional groups or, at most, ether groups. Examples of such alcohols are, for example, bifunctional alcohols such as ethylene glycol, propylene glycol, and their more highly condensed representatives, for example diethylene glycol, triethylene glycol, dipropylene glycol, tripropylene glycol, etc., butanediol, pentanediol, hexanediol, neopentyl glycol, alkoxylated phenolic compounds such as ethoxylated or propoxylated bisphenols, cyclohexanedimethanol, trifunctional and higher-functionality alcohols such as glycerol, trimethylolpropane, butanetriol, trimethylolethane, pentaerythritol, ditrimethylolpropane, dipentaerythritol, sorbitol, mannitol and the corresponding alkoxylated, especially ethoxylated and propoxylated, alcohols.

Further useful reactive diluents of group (C.2.1) are polyester(meth)acrylate, which is the (meth)acrylic esters of polyesterols.

Useful polyesterols include, for example, those which can be prepared by esterifying polycarboxylic acids, preferably dicarboxylic acids, with polyols, preferably diols. The starting materials for such hydroxyl-containing polyesters are known to those skilled in the art. The dicarboxylic acids used may be succinic acid, glutaric acid, adipic acid, sebacic acid, o-phthalic acid, and their isomers and hydrogenation products, and also esterifiable or transesterifiable derivatives of the acids mentioned, for example anhydrides or dialkyl esters. Useful polyols include the abovementioned alcohols, preferably ethylene glycol, 1,2- and 1,3-propylene glycol, 1,4-butanediol, 1,6-hexanediol, neopentyl glycol, cyclohexanedimethanol and polyglycols of the ethylene glycol and propylene glycol type.

Also useful as reactive diluents of group (C.2.1) are 1,4-divinylbenzene, triallyl cyanurate, acrylic esters of tricyclodecenyl alcohol of the following formula

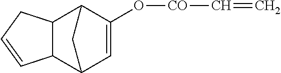

also known by the name dihydrodicyclopentadienyl acrylate, and the allyl esters of acrylic acid, of methacrylic acid and of cyanoacrylic acid.

Among the reactive diluents of group (C.2.1) mentioned by way of example, those used are especially, with regard to the preferred inventive mixtures addressed above, those which comprise photopolymerizable groups.

The group (C.2.2) includes, for example, di- or polyhydric alcohols, for example ethylene glycol, propylene glycol, and their more highly condensed representatives, for example diethylene glycol, triethylene glycol, dipropylene glycol, tripropylene glycol, etc., butanediol, pentanediol, hexanediol, neopentyl glycol, cyclohexanedimethanol, glycerol, trimethylolpropane, butanetriol, trimethylolethane, pentaerythritol, ditrimethylolpropane, dipentaerythritol, sorbitol, mannitol and the corresponding alkoxylated, especially ethoxylated and propoxylated, alcohols.

The group (C.2.2) also includes, for example, alkoxylated phenolic compounds, for instance ethoxylated or propoxylated bisphenols.

These reactive diluents may also, for example, be epoxide(meth)acrylates or urethane(meth)acrylates.

Epoxide(meth)acrylates are, for example, those as obtainable by reaction, known to those skilled in the art, of epoxidized olefins or poly- or diglycidyl ethers, such as bisphenol A diglycidyl ether, with (meth)acrylic acid.

Urethane(meth)acrylates are, in particular, reaction products, likewise known to those skilled in the art, of hydroxyalkyl(meth)acrylates with poly- or diisocyanates.

Such epoxide(meth)acrylates or urethane (meth)acrylates should be regarded as “mixed forms” of the compounds listed under groups (C.2.1) and (C.2.2).

When reactive diluents are used, their amount and properties have to be adjusted to the particular conditions in such a way that, on the one hand, a satisfactory desired effect, for example the desired color of the inventive mixtures, is achieved, but, on the other hand, the phase behavior of the liquid-crystalline mixture is not too greatly impaired. For the preparation of low-crosslinking (high-crosslinking) liquid-crystalline mixtures, it is possible, for example, to use corresponding reactive diluents which have a relatively low (high) number of reactive units per molecule.

The reactive diluents are typically used in a proportion of from 0.5 to 20.0% by weight based on the total weight of the liquid-crystalline mixture.

Components (a.1), (a.2) or (a.3), or mixtures which comprise these components, may also comprise small amounts of polymerizable diluents. Preferred polymerizable solvents which can be added to (a.1), (a.2) or (a.3) are acrylates, especially higher-functionality acrylates such as bis-, tris- or tetraacrylates, more preferably high-boiling oligoacrylates. The preferred amount added is about 5% by weight based on the total weight of the composition.

Group (C.3) of the diluents includes, for example, C₁-C₄-alcohols, for example methanol, ethanol, n-propanol, isopropanol, butanol, isobutanol, sec-butanol, tert-butanol, and the C₅-C₁₂-alcohols n-pentanol, n-hexanol, n-heptanol, n-octanol, n-nonanol, n-decanol, n-undecanol and n-dodecanol and isomers thereof, glycols, for example 1,2-ethylene glycol, 1,2- or 1,3-propylene glycol, 1,2-, 2,3- or 1,4-butylene glycol, di- or triethylene glycol or di- or tripropylene glycol, ethers, for example open-chain ethers such as methyl tert-butyl ether, 1,2-ethylene glycol monomethyl or dimethyl ether, 1,2-ethylene glycol monoethyl or diethyl ether, 3-methoxypropanol or 3-isopropoxypropanol, or cyclic ethers such as tetrahydrofuran or dioxane, open-chain ketones, for example acetone, methyl ethyl ketone, methyl isobutyl ketone or diacetone alcohol(4-hydroxy-4-methyl-2-pentanone), cyclic ketones such as cyclopentanone, C₁-C₅-alkyl esters, for example methyl acetate, ethyl acetate, propyl acetate, butyl acetate or amyl acetate, C₁-C₄-alkoxy-C₁-C₄-alkyl esters such as 1-methoxyprop-2-yl acetate, carboxamides such as dimethylformamide and dimethylacetamide, N-heterocycles such as N-methylpyrrolidone, aliphatic or aromatic hydrocarbons, for example pentane, hexane, heptane, octane, isooctane, petroleum ether, toluene, xylene, ethylbenzene, tetralin, decalin, dimethylnaphthalene, white spirit, Shellsol® or Solvesso®, mineral oils, for example gasoline, kerosene, diesel oil or heating oil, but also natural oils, for example olive oil, soybean oil, rapeseed oil, linseed oil or sunflower oil. As a matter of course, mixtures of these diluents are also useful for use in the inventive mixtures.

When there is at least partial miscibility, these diluents may also be mixed with water. Useful diluents in this context are, for instance, C₁-C₄-alcohols, e.g. methanol, ethanol, n-propanol, isopropanol, butanol, isobutanol or sec-butanol, glycols, e.g. 1,2-ethylene glycol, 1,2- or 1,3-propylene glycol, 1,2-, 2,3- or 1,4-butylene glycol, di- or triethylene glycol or di- or tripropylene glycol, ethers, e.g. tetrahydrofuran or dioxane, ketones, e.g. acetone, methyl ethyl ketone or diacetone alcohol(4-hydroxy-4-methyl-2-pentanone), or C₁-C₄-alkyl esters, for example methyl acetate, ethyl acetate, propyl acetate or butyl acetate. Such aqueous mixtures often have limited miscibility with relatively nonpolar diluents, for example the aliphatic or aromatic hydrocarbons already mentioned, mineral oils but also natural oils, which then also allows ternary (or quasi-ternary) diluents composed of water, at least partly water-miscible and water-immiscible diluents to be prepared and used.

Suitable diluents for the compounds of groups (a.1) or (a.2) are especially linear or branched esters, particularly acetic esters, C₁-C₄-alkoxy-C₁-C₄-alkyl esters such as 1-methoxyprop-2-yl acetate, cyclic esters, carboxamides such as dimethylformamide and dimethylacetamide, open-chain and cyclic ethers, alcohols, lactones, open-chain and cyclic ketones, and aliphatic and aromatic hydrocarbons such as toluene, xylene and cyclohexane. Preferred diluents for the compounds of groups (a.1) or (a.2) are C₁-C₄-alkoxy-C₁-C₄-alkyl esters such as 1-methoxyprop-2-yl acetate, carboxamides such as dimethylformamide and dimethylacetamide, open-chain ethers such as 1,2-ethylene glycol mono- or dimethyl ether, 1,2-ethylene glycol mono- or diethyl ether, 3-methoxypropanol or 3-isopropoxypropanol, open-chain and cyclic ketones, such as acetone, methyl ethyl ketone, methyl isobutyl ketone, diacetone alcohol(4-hydroxy-4-methyl-2-pentanone) or cyclopentanone, alcohols such as methanol, ethanol, n-propanol, isopropanol, butanol, isobutanol, sec-butanol, tert-butanol, n-pentanol, n-hexanol, n-heptanol, n-octanol, n-nonanol, n-decanol, n-undecanol and n-dodecanol, lactones such as N-methylpyrrolidone, and aromatics such as toluene. Greater preference is given to said carboxamides, open-chain ethers, open-chain and cyclic ketones and lactones. In particular, said open-chain and cyclic ketones or mixtures thereof are used.

Suitable diluents for the polymers of group (a.3) are in particular ethers and cyclic ethers such as tetrahydrofuran or dioxane, chlorinated hydrocarbons such as dichloromethane, trichloromethane, carbon tetrachloride, dichloroethane, 1,1,2,2-tetrachloroethane, 1-chloronaphthalene, chlorobenzene or 1,2-dichlorobenzene. These diluents are particularly suitable for polyesters and polycarbonates. Suitable diluents for cellulose derivatives are, for example, ethers, such as dioxane, or ketones such as acetone.

The diluents are used typically in a proportion of from about 0.5 to 10.0% by weight, preferably from about 1.0 to 5.0% by weight, based on the total weight of the composition.

When the composition is a solution or dispersion, the proportion of diluent is preferably from 5 to 95% by weight, more preferably from 30 to 80% by weight and in particular from 40 to 70% by weight, based on the total weight of the composition.

The effect of the defoamers and deaerating agents (C.4), lubricants and leveling agents (C.5), thermally curing or radiation-curing auxiliaries (C.6), substrate wetting auxiliaries (C.7), wetting and dispersing auxiliaries (C.8), hydrophobizing agents (C.9), adhesion promoters (C.10) and auxiliaries for improving scratch resistance (C.1) listed under component C usually cannot be strictly distinguished from one another. For instance, lubricants and leveling agents often additionally act as defoamers and/or deaerating agents and/or as auxiliaries for improving scratch resistance. Radiation-curing auxiliaries can in turn act as lubricants and leveling agents and/or deaerating agents and/or also as substrate wetting auxiliaries. In the individual case, some of these auxiliaries may also perform the function of an adhesion promoter (C.1). In accordance with the above statements, a certain additive may therefore be attributed to more than one of the groups (C.4) to (C.1) described below.

The defoamers of group (C.4) include silicon-free and silicon-containing polymers. The silicon-containing polymers are, for example, unmodified or modified polydialkylsiloxanes or branched copolymers, comb copolymers or block copolymers composed of polydialkylsiloxane and polyether units, the latter being obtainable from ethylene oxide or propylene oxide.

The deaerating agents of group (C.4) include, for example, organic polymers, for instance polyethers and polyacrylates, dialkylpolysiloxanes, especially dimethylpolysiloxanes, organically modified polysiloxanes, for instance arylalkyl-modified polysiloxanes, or else fluorosilicones. The action of defoamers is based essentially on preventing foam formation or destroying foam which has already formed. Deaerating agents act essentially in such a way that they promote the coalescence of finely distributed gas or air bubbles to larger bubbles in the medium to be deaerated, for example the inventive mixtures, and hence accelerate the escape of the gas (or of the air). Since defoamers can often also be used as deaerating agents and vice versa, these additives have been combined together under group (C.4). Such auxiliaries are, for example, obtainable commercially from Tego as TEGO® Foamex 800, TEGO® Foamex 805, TEGO® Foamex 810, TEGO® Foamex 815, TEGO® Foamex 825, TEGO® Foamex 835, TEGO® Foamex 840, TEGO® Foamex 842, TEGO® Foamex 1435, TEGO® Foamex 1488, TEGO® Foamex 1495, TEGO® Foamex 3062, TEGO® Foamex 7447, TEGO® Foamex 8020, Tego® Foamex N, TEGO® Foamex K 3, TEGO® Antifoam 2-18, TEGO® Antifoam 2-57, TEGO® Antifoam 2-80, TEGO® Antifoam 2-82, TEGO® Antifoam 2-89, TEGO® Antifoam 2-92, TEGO® Antifoam 14, TEGO® Antifoam 28, TEGO® Antifoam 81, TEGO® Antifoam D 90, TEGO® Antifoam 93, TEGO® Antifoam 200, TEGO® Antifoam 201, TEGO® Antifoam 202, TEGO® Antifoam 793, TEGO® Antifoam 1488, TEGO® Antifoam 3062, TEGOPREN® 5803, TEGOPREN® 5852, TEGOPREN® 5863, TEGOPREN® 7008, TEGO® Antifoam 1-60, TEGO® Antifoam 1-62, TEGO® Antifoam 1-85, TEGO® Antifoam 2-67, TEGO® Antifoam WM 20, TEGO® Antifoam 50, TEGO® Antifoam 105, TEGO® Antifoam 730, TEGO® Antifoam MR 1015, TEGO® Antifoam MR 1016, TEGO® Antifoam 1435, TEGO® Antifoam N, TEGO® Antifoam KS 6, TEGO® Antifoam KS 10, TEGO® Antifoam KS 53, TEGO® Antifoam KS 95, TEGO® Antifoam KS 100, TEGO® Antifoam KE 600, TEGO® Antifoam KS 911, TEGO® Antifoam MR 1000, TEGO® Antifoam KS 100, Tego® Airex 900, Tego® Airex 910, Tego® Airex 931, Tego® Airex 935, Tego® Airex 960, Tego® Airex 970, Tego® Airex 980 and Tego® Airex 985, and from BYK as BYK10-011, BYK®-019, BYK®-020, BYK®-021, BYK®-022, BYK®-023, BYK®-024, BYK®-025, BYK®-027, BYK®-031, BYK®-032, BYK®-033, BYK®-034, BYK®-035, BYK®-036, BYK®-037, BYK®-045, BYK®-051, BYK®-052, BYK®-053, BYK®-055, BYK®-057, BYK®-065, BYK®-067, BYK®-070, BYK®-080, BYK®-088, BYK10-141 and BYK®-A 530.

The auxiliaries of group (C.4) are typically used in a proportion of from about 0.05 to 3.0% by weight, preferably from about 0.5 to 2.0% by weight, based on the total weight of the liquid-crystalline mixture.

The group (C.5) of the lubricants and leveling agents includes, for example, silicon-free but also silicon-containing polymers, for example polyacrylates or modified low molecular weight polydialkylsiloxanes. The modification consists in replacing some of the alkyl groups with a wide variety of organic radicals. These organic radicals are, for example, polyethers, polyesters or else long-chain alkyl radicals, the former finding most frequent use.

The polyether radicals of the correspondingly modified polysiloxanes are typically formed by means of ethylene oxide and/or propylene oxide units. The higher the proportion of these alkylene oxide units is in the modified polysiloxane, the more hydrophilic is generally the resulting product.

Such auxiliaries are obtainable commercially, for example, from Tego as TEGO® Glide 100, TEGO® Glide ZG 400, TEGO® Glide 406, TEGO® Glide 410, TEGO® Glide 411, TEGO® Glide 415, TEGO® Glide 420, TEGO® Glide 435, TEGO® Glide 440, TEGO® Glide 450, TEGO® Glide A 15, TEGO® Glide B 1484 (also usable as a defoamer and deaerating agent), TEGO® Flow ATF, TEGO® Flow ATF2, TEGO® Flow 300, TEGO® Flow 460, TEGO® Flow 425 and TEGO® Flow ZFS 460. The radiation-curable lubricants and leveling agents used, which additionally also serve to improve scratch resistance, can be the products TEGO® Rad 2100, TEGO® Rad 2200, TEGO® Rad 2300, TEGO® Rad 2500, TEGO® Rad 2600, TEGO® Rad 2700 and TEGO® Twin 4000, likewise obtainable from Tego. Such auxiliaries are obtainable from BYK, for example as BYK®-300, BYK®-306, BYK®-307, BYK®-310, BYK®-320, BYK®-322, BYK®-331, BYK®-333, BYK®-337, BYK®-341, Byk® 354, Byk® 361 N, BYK®-378 and BYK®-388.

The auxiliaries of group (C.5) are typically used in a proportion of from about 0.05 to 3.0% by weight, preferably from about 0.5 to 2.0% by weight, based on the total weight of the liquid-crystalline mixture.

Group (C.6) includes, as radiation-curing auxiliaries, in particular polysiloxanes with terminal double bonds which are, for example, part of an acrylate group. Such auxiliaries can be made to crosslink by actinic or, for example, electron beam radiation. These auxiliaries generally combine several properties in one. In the uncrosslinked state, they can act as defoamers, deaerating agents, lubricants and leveling agents and/or substrate wetting aids; in the crosslinked state, they increase in particular the scratch resistance, for example of coatings or films which can be produced with the inventive mixtures. The improvement in the shine performance, for example, coatings or films can essentially be regarded as the effect of the action of these auxiliaries as defoamers, devolatilizers and/or lubricants and leveling agents (in the uncrosslinked state). The radiation-curing auxiliaries which can be used are, for example, the products TECO® Rad 2100, TEGO® Rad 2200, TEGO® Rad 2500, TEGO® Rad 2600 and TEGO® Rad 2700 obtainable from Tego, and the product BYK®-371 obtainable from BYK. Thermally curing auxiliaries of group (C.6) comprise, for example, primary OH groups which can react with isocyanate groups, for example, of the binder.

The thermally curing auxiliaries used can, for example, be the products BYK®-370, BYK®-373 and BYK®-375 obtainable from BYK. The auxiliaries of group (C.6) are typically used in a proportion of from about 0.1 to 5.0% by weight, preferably from about 0.1 to 3.0% by weight, based on the total weight of the liquid-crystalline mixture.

The auxiliaries of group (C.7) of the substrate wetting aids serve in particular to increase the wettability of the substrate, which is to be imprinted or coated, for instance, by printing inks or coating compositions, for example compositions (a.1) to (a.5). The generally associated improvement in the lubricating and leveling performance of such printing inks or coating compositions has an effect on the appearance of the finished (for example crosslinked) print or of the finished (for example crosslinked) layer. A wide variety of such auxiliaries are commercially available, for example, from Tego as TEGO® Wet KL 245, TEGO® Wet 250, TEGO® Wet 260 and TEGO® Wet ZFS 453, and from BYK as BYK®-306, BYK®-307, BYK®-310, BYK®-333, BYK®-344, BYK®-345, BYK®-346 and Byk®-348.

Also very suitable are the products of the Zonyl® brand from Dupont, such as Zonyl® FSA and Zonyl® FSG. These are fluorinated surfactants/wetting agents.

The auxiliaries of group (C.7) are typically used in a proportion of from about 0.01 to 3.0% by weight, preferably from about 0.01 to 1.5% by weight and especially from 0.03 to 1.5% by weight, based on the total weight of the liquid-crystalline mixture.

The auxiliaries of group (C.8) of the wetting and dispersing aids serve in particular to prevent the leaching and floating and also the settling of pigments, and are therefore useful, if necessary, in pigmented compositions in particular.

These auxiliaries stabilize pigment dispersions essentially by electrostatic repulsion and/or steric hindrance of the additized pigment particles, the interaction of the auxiliary with the surrounding medium (for example binder) playing a major role in the latter case. Since the use of such wetting and dispersing aids is common practice, for example, in the technical field of printing inks and paints, the selection of such a suitable auxiliary in the given case generally presents no difficulties to the person skilled in the art.

Such wetting and dispersing aids are supplied commercially, for example, by Tego as TEGO® Dispers 610, TEGO® Dispers 610 S, TEGO® Dispers 630, TEGO® Dispers 700, TEGO® Dispers 705, TEGO® Dispers 710, TEGO® Dispers 720 W, TEGO® Dispers 725 W, TEGO® Dispers 730 W, TEGO® Dispers 735 W and TEGO® Dispers 740 W, and by BYK as Disperbyk®, Disperbyk®-107, Disperbyk®-108, Disperbyk®-110, Disperbyk®-111, Disperbyk®-115, Disperbyk®-130, Disperbyk10-160, Disperbyk®-161, Disperbyk®-162, Disperbyk®-163, Disperbyk®-164, Disperbyk®-165, Disperbyk®-166, Disperbyk®-167, Disperbyk®-170, Disperbyk®-174, Disperbyk®-180, Disperbyk®-181, Disperbyk®-182, Disperbyk®-183, Disperbyk®-184, Disperbyk®-185, Disperbyk®-190, Anti-Terra®-U, Anti-Terra®-U 80, Anti-Terra®-P, Anti-Terra®-203, Anti-Terra®-204, Anti-Terra® 5 206, BYK®-151, BYK®-154, BYK®-155, BYK®-P 104 S, BYK®-P 105, Lactimon®, Lactimon®-WS and Bykumen®. The abovementioned Zonyl® brands, such as Zonyl® FSA and Zonyl® FSG, from DuPont are also useful here.

The dosage of the auxiliaries of group (C.8) depends mainly upon the surface area of the pigments to be covered and upon the mean molar mass of the auxiliary.

For inorganic pigments and low molecular weight auxiliaries, a content of the latter of from about 0.5 to 2.0% by weight based on the total weight of pigment and auxiliary is typically assumed. In the case of high molecular weight auxiliaries, the content is increased to from about 1.0 to 30% by weight.

In the case of organic pigments and low molecular weight auxiliaries, the content of the latter is from about 1.0 to 5.0% by weight based on the total weight of pigment and auxiliary. In the case of high molecular weight auxiliaries, this content may be in the range from about 10.0 to 90% by weight. In every case, therefore, preliminary experiments are recommended, which can, though, be accomplished by the person skilled in the art in a simple manner.

The hydrophobizing agents of group (C.9) can be used with a view, for example, to providing prints or coatings obtained with inventive mixtures with water-repellent properties. This means that swelling resulting from water absorption and hence a change, for example, in the optical properties of such prints or coatings is no longer possible or at least greatly suppressed. In addition, when the mixtures are used, for example, as a printing ink in offset printing, their absorption of water can be prevented or at least greatly inhibited. Such hydrophobizing agents are commercially available, for example, from Tego as Tego® Phobe WF, Tego® Phobe 1000, Tego® Phobe 1000 S, Tego® Phobe 1010, Tego® Phobe 1030, Tego® Phobe 1040, Tego® Phobe 1050, Tego® Phobe 1200, Tego® Phobe 1300, Tego® Phobe 1310 and Tego® Phobe 1400.

The auxiliaries of group (C.9) are used typically in a proportion of from about 0.05 to 5.0% by weight, preferably from about 0.1 to 3.0% by weight, based on the total weight of the liquid-crystalline mixture.

Adhesion promoters of group (C.10) serve to improve the adhesion between two interfaces in contact. It immediately becomes evident from this that essentially only the proportion of the adhesion promoter which is present in one interface, the other interface or in both interfaces is effective. When the intention is to apply, for example, liquid or pasty printing inks, coatings or paints to a solid substrate, this generally means that either the adhesion promoter has to be added directly to the latter or the substrate has to be subjected to a pretreatment with the adhesion promoters (also known as priming), i.e. that changed chemical and/or physical surface properties are imparted to this substrate.

When the substrate has been primed beforehand with a background color, this means that the interfaces in contact are now that of the background color on the one hand and that of the printing ink or of the coating or paint on the other hand. Thus, in this case, not only the adhesion properties between substrate and background color, but also between background color and printing ink or coating or paint, play a role for the adhesion of the entire combination on the substrate. It is also possible for the substrate wetting aids already detailed under group (C.7) to be addressed as adhesion promoters in the wider sense, but these generally do not have the same capacity for adhesion promotion.

With regard to the wide variety of physical and chemical properties of substrates and of printing inks, coatings and paints intended, for example, for the printing or coating thereof the multitude of adhesion promoter systems is not surprising. Adhesion promoters based on silanes are, for example, 3-aminopropyltrimethoxysilane, 3-aminopropyltriethoxysilane, 3-aminopropylmethyldiethoxysilane, N-aminoethyl-3-aminopropyltrimethoxysilane, N-aminoethyl-3-aminopropylmethyldimethoxysilane, N-methyl-3-aminopropyltrimethoxysilane, 3-ureidopropyltriethoxysilane, 3-methacryloyloxypropyltrimethoxysilane, 3-glycidyloxypropyltrimethoxysilane, 3-mercaptopropyltrimethoxysilane, 3-chloropropyltrimethoxysilane or vinyltrimethoxysilane. These and further silanes are obtainable, for example, under the brand name DYNASILAN® from Hüls.

Adhesion promoters based on titanates/zirconates and titanium/zirconium bisacetylacetonates correspond, for example, to the following formulae

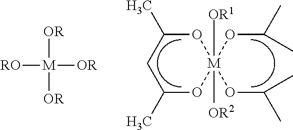

in which M is titanium or zirconium, and R, R¹ and R² are each C₁-C₄-alkyl, for example isopropyl or n-butyl. Examples of such compounds are, for instance, tetraisopropyl titanate, tetra-n-butyl titanate, titanium bis(acetylacetonate)diisopropoxide, titanium bis(acetylacetonate)dibutoxide, titanium bis(acetylacetonate)monobutoxide monoisopropoxide or titanium bis(acetylacetonate)monoethoxide monoisopropoxide.

Further titanium and zirconium compounds usable as adhesion promoters are n-butyl polytitanate, isopropyl triisostearoyltitanate, isopropyl tris(N-ethylaminoethylamino)-titanate and zirconium bis(diethylcitrate) diisopropoxide. These and further titanium and zirconium compounds are obtainable, for example, under the brand names TYZOR® (from DuPont), Ken-React® (from Kenrich Petrochemicals Inc.) and Tilcom® (from Tioxide Chemicals). The adhesion promoters used may also be zirconium aluminates, as obtainable, for example, under the brand name Manchem® (from Rhône Poulenc). Further examples of useful adhesion-promoting additives in printing inks or paints are chlorinated polyolefins (obtainable, for example, from Eastman Chemical and Toyo Kasei), polyesters (obtainable, for example, from Hüs AG, BASF SE, Gebr. Borchers AG, Pluess-Staufer AG, Hoechst AG and Worlee), compounds based on sucrose, for example sucrose benzoate or sucrose acetoisobutyrate (the latter obtainable, for example, from Eastman Chemical), phosphoric esters (obtainable, for example, from The Lubrizol Company and Hoechst AG) and polyethyleneimines (obtainable, for example, from BASF SE), and examples of useful adhesion-promoting additives in printing inks for flexographic printing, film printing and packaging printing are rosin esters (obtainable, for example from Robert Kraemer GmbH).

Typically, the substrate to be printed or to be coated will be pretreated appropriately, i.e. such additives will be used as primers. Appropriate technical information for this purpose can generally be learnt from the manufacturers of such additives, or the person skilled in the art can obtain this information in a simple manner by appropriate preliminary experiments.

Should these additives, however, be added as auxiliaries of group (C.10) to the inventive mixtures, their content is typically from about 0.05 to 5.0% by weight based on the total weight of the liquid-crystalline mixture. These concentration data serve merely as an indication, since amount and identity of the additive are determined in the individual case by the nature of the substrate and the printing/coating composition. Typically, appropriate technical information for this case is available from the manufacturers of such additives, or can be determined by the person skilled in the art by appropriate preliminary experiments in a simple manner.

The group (C.1) of the auxiliaries for improving scratch resistance includes, for example, the products TEGO® Rad 2100, TECO® Rad 2200, TEGO® Rad 2500, TEGO® Rad 2600 and TEGO® Rad 2700 which are obtainable from Tego and have already been mentioned above.

For these auxiliaries, useful amounts are likewise those mentioned in group (C.6), i.e. these additives are typically used in a proportion of from about 0.1 to 5.0% by weight, preferably from about 0.1 to 3.0% by weight, based on the total weight of the liquid-crystalline mixture.

The group (D.1) of the dyes includes, for example, dyes from the class of the azo dyes, metal complex dyes, basic dyes such as di- and triarylmethane dyes and salts thereof, azomethine derivatives, polymethines, antraquinone dyes and the like. An overview of suitable dyes which can be used in the inventive mixture is given by the book by H. Zollinger, “Color Chemistry”, Wiley-VCH, Weinheim, 3rd edition 2003.

It is in particular also possible to add to the inventive mixtures photochromic, thermochromic or luminescent dyes, and dyes which have a combination of these properties. In addition to the typical fluorescent dyes, fluorescent dyes should also be understood to mean optical brighteners.

Examples of the latter include the class of the bisstyrylbenzenes, especially of the cyanostyryl compounds, and correspond to the formula

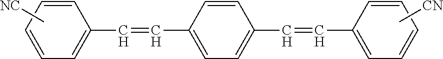

Further suitable optical brighteners from the class of the stilbenes are, for example, those of the formulae

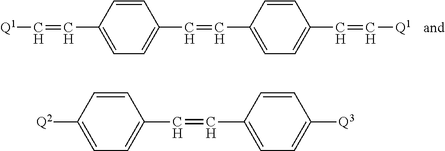

in which Q¹ is in each case C₁-C₄-alkoxycarbonyl or cyano, Q² is benzoxazol-2-yl, which may be mono- or disubstituted by C₁-C₄-alkyl, especially methyl, Q³ is C₁-C₄-alkoxycarbonyl or 3-(C₁-C₄-alkyl)-1,2,4-oxadiazol-3-yl.

Further suitable optical brighteners from the class of the benzoxazoles obey, for example, the formulae

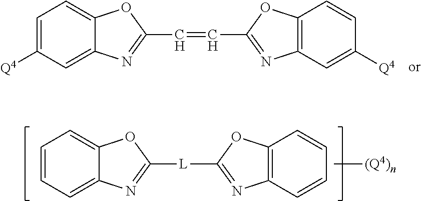

in which Q⁴ is in each case C₁-C₄-alkyl, especially methyl, L is a radical of the formula

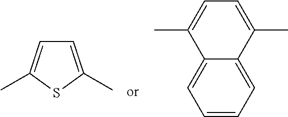

and n is an integer from 0 to 2.

Suitable optical brighteners from the class of the coumarins have, for example, the formula

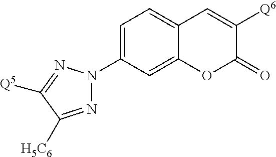

in which
Q⁵ is C₁-C₄-alkyl and
Q⁶ is phenyl or 3-halopyrazol-1-yl, especially 3-chloropyrazol-1-yl.

Further suitable optical brighteners from the class of the pyrenes correspond, for example, to the formula

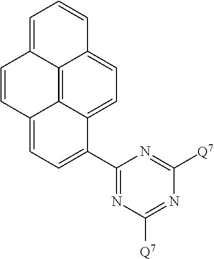

in which
Q⁷ is in each case C₁-C₄-alkoxy, especially methoxy.

The abovementioned brighteners can be used either alone or in a mixture with one another.

The abovementioned optical brighteners are generally commercially available products known per se. They are described, for example, in Ullmann's Encyclopedia of Industrial Chemistry, 5^{th} edition, volume A18, pages 156 to 161, or can be obtained by the methods described there.

In particular, if desired, one or more optical brighteners from the class of the bisstyrylbenzenes is used, especially of the cyanostyrylbenzenes. The latter may be used as individual compounds, but also as a mixture of the isomeric compounds.

In this case, the isomers correspond to the formulae

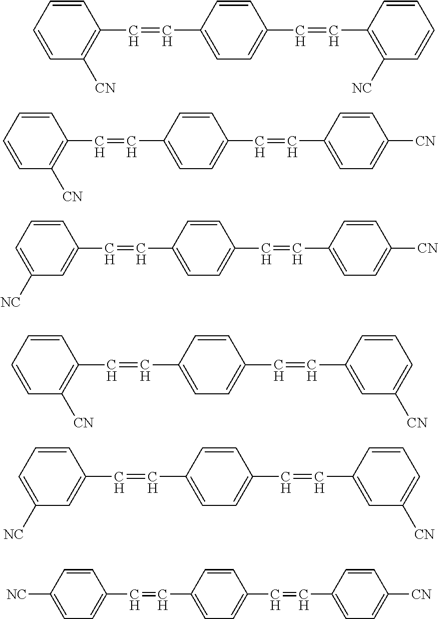

Optical brighteners are sold, for example, commercially as Ultraphor® SF 004, Ultraphor® SF MO, Ultraphor® SF MP and Ultraphor® SF PO from BASF SE.

The group (D.2) of the pigments includes both inorganic and organic pigments. An overview of inorganic colored pigments which can be used in the inventive mixtures is given by the book by H. Endriβ “Aktuelle anorganische Bunt-Pigmente” [“Current inorganic colored pigments”] (publisher U. Zorll, Curt-R.-Vincentz-Verlag Hanover 1997), and the book by G. Buxbaum, “Industrial Inorganic Pigments”, Wiley-VCH, Weinheim, 3rd edition 2005. In addition, useful further pigments which are not listed in the aforementioned book are also Pigment Black 6 and Pigment Black 7 (carbon black), Pigment Black 1 (iron oxide black, Fe₃O₄), Pigment White 4 (zinc oxide, ZnO), Pigment White 5 (lithopone, ZnS/BaSO₄), Pigment White 6 (titanium oxide, TiO₂) and Pigment White 7 (zinc sulfide, ZnS).

An overview of organic pigments which can be added to the inventive mixtures is provided by the book by W. Herbst and K. Hunger “Industrielle organische Pigmente” [“Industrial Organic Pigments”], Wiley-VCH, Weinheim, 3rd edition 2004.

It is also possible to add to the inventive mixtures magnetic, electrically conductive, photochromic, thermochromic or luminescent pigments, and also pigments which have a combination of these properties.

In addition to some organic pigments, for example Lumogen® Yellow 0790 (BASF SE), useful pigments having luminescent properties are also inorganic, doped or undoped compounds essentially based on alkaline earth metal oxides, alkaline earth metal/transition metal oxides, alkaline earth metal/aluminum oxides, alkaline earth metal/silicon oxides or alkaline earth metal/phosphorus oxides, alkaline earth metal halides, Zn/silicon oxides, Zn/alkaline earth metal halides, rare earth metal oxides, rare earth metal/transition metal oxides, rare earth metal/aluminum oxides, rare earth metal/silicon oxides or rare earth metal/phosphorus oxides, rare earth metal oxide sulfides or oxide halides, zinc oxide, sulfide or selenide, cadmium oxide, sulfide or selenide or zinc/cadmium oxide, sulfide or selenide, the cadmium compounds being of lower importance owing to their toxicological and ecological relevance.

The dopants used in these compounds are usually aluminum, tin, antimony, rare earth metals, such as cerium, europium or terbium, transition metals, such as manganese, copper, silver or zinc, or combinations of these elements.

Luminescent pigments are specified below by way of example, the notation “compound:element(s)” being taken to mean to the relevant person skilled in the art that said compound has been doped with the corresponding element(s). In addition, for example, the notation “(P,V)”, denotes that the corresponding lattice positions in the solid structure of the pigment are randomly occupied by phosphorus and vanadium.

Examples of such compounds which are capable of luminescence are MgWO₄, CaWO₄, Sr₄Al₁₄O₂₅:Eu, BaMg₂Al₁₀O₂₇:Eu, MgAl₁₁O₁₉:Ce,Tb, MgSiO₃:Mn, Ca₁₀(PO₄)₆(F,Cl):Sb,Mn, (SrMg)₂P₂O₇:Eu, SrMg₂P₂O₇:Sn, BaFCl:Eu, Zn₂SiO₄:Mn, (Zn,Mg)F₂:Mn, Y₂O₃:Eu, YVO₄:Eu, Y(P,V)O₄:Eu, Y₂SiO₅:Ce,Tb, Y₂O₂S:Eu, Y₂O₂S:Tb, La₂O₂S:Tb, Gd₂O₂S:Tb, LaOBr:Tb, ZnO:Zn, ZnS:Mn, ZnS:Ag, ZnS/CdS:Ag, ZnS:Cu,Al, ZnSe:Mn, ZnSe:Ag and ZnSe:Cu.

Since the inventive film is preferably intended to be essentially transparent, the components of group D are used in not more than such amounts that the film transmits at least 80% of the incident radiation with a wavelength of from 350 to 750 nm. Component D is used to impart a tint to the film, if desired. In order to ensure maximum transparency, the compounds of component D used are preferably those having a particle size of not more than 20 nm.

Examples of light, heat and/or oxidation stabilizers as component E include: alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which have a linear or branched side chain, for example 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures of these compounds, alkylthiomethylphenols, such as 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol, hydroquinones and alkylated hydroquinones, such as 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate and bis(3,5-di-tert-butyl-4-hydroxyphenyl)adipate, tocopherols, such as α-tocopherol, β-tocopherol, γ-tocopherol, δ-tocopherol and mixtures of these compounds, and tocopherol derivatives, such as tocopheryl acetate, succinate, nicotinate and polyoxyethylenesuccinate (“tocofersolate”), hydroxylated diphenyl thioethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol) and 4,4′-bis(2,6-dimethyl-4-hydroxyphenyl)disulfide, alkylidenebisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methyl phenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecyl-mercaptobutane and 1,1,5,5-tetrakis(5-tert-butyl-4-hydroxy-2-methylphenyl)pentane, O-, N- and S-benzyl compounds, such as 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide and isooctyl-3,5-di-tert-butyl-4-hydroxybenzylmercaptoacetate, aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene and 2,4,6-tris(3,5-di-tert-butyl-4-hydroxybenzyl)phenol, triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris-(3,5-di-tert-butyl-4-hydroxyphenylpropionyl)hexahydro-1,3,5-triazine, 1,3,5-tris(3,5-dicyclohexyl-4-hydroxybenzyl)isocyanurate and 1,3,5-tris(2-hydroxyethyl)isocyanurate, benzylphosphonates, such as dimethyl 2,5-di-tert-butyl-4-hydroxybenzylphosphonate, diethyl 3,5-di-tert-butyl-4-hydroxybenzylphosphonate, dioctadecyl 3, 5-di-tert-butyl-4-hydroxybenzylphosphonate and dioctadecyl 5-tert-butyl-4-hydroxy-3-methylbenzylphosphonate, acylaminophenols, such as 4-hydroxylauroylanilide, 4-hydroxystearoylanilide and octyl N-(3,5-di-tert-butyl-4-hydroxyphenyl)carbamate, propionic and acetic esters, for example of monohydric or polyhydric alcohols, such as methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane and 4-hydroxymethyl-1-phospha-2,6,7-trioxabicyclo[2.2.2]octane, propionamides based on amine derivatives, such as N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine and N,N′-bis(3,5-di-tert-butyl-4-hydroxyphenylpropionyl)hydrazine, ascorbic acid (Vitamin C) and ascorbic acid derivatives, such as ascorbyl palmitate, laurate and stearate, and ascorbyl sulfate and phosphate, antioxidants based on amine compounds, such as N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octyl-substituted diphenylamine, such as p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis[4-methoxyphenyl)amine, 2,6-di-tert-butyl-4-dimethylaminomethylphenol, 2,4-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octyl-substituted N-phenyl-1-naphthylamine, a mixture of mono- and dialkylated tert-butyl/tert-octyldiphenylamine, a mixture of mono- and dialkylated nonyldiphenylamine, a mixture of mono- and dialkylated dodecyldiphenylamine, a mixture of mono- and dialkylated isopropyl/isohexyldiphenylamine, a mixture of mono- and dialkylated tert-butyldiphenylamine, 2,3-dihydro-3,3-dimethyl-4H-1,4-benzothiazine, phenothiazine, a mixture of mono- and dialkylated tert-butyl/tert-octylphenothiazine, a mixture of mono- and dialkylated tert-octylphenothiazine, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl)sebacate, 2,2,6,6-tetramethylpiperidin-4-one and 2,2,6,6-tetramethylpiperidin-4-ol, phosphites and phosphonites, such as triphenylphosphite, diphenyl alkyl phosphite, phenyl dialkyl phosphite, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyloxy pentaerythritol diphosphite, bis(2,4-di-tert-butyl-6-methylphenyl)pentaerythritol diphosphite, bis(2,4,6-tris(tert-butylphenyl))pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl)methyl phosphite and bis(2,4-di-tert-butyl-6-methylphenyl)ethyl phosphite, 2-(2′-hydroxyphenyl)benzotriazoles, such as 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, a mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of complete esterification of 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃]₂, where R=3′-tert-butyl-4′-hydroxy-5′-2H-benzotriazol-2-ylphenyl], sulfur-containing peroxide scavengers and sulfur-containing antioxidants, such as esters of 3,3′-thiodipropionic acid, for example the lauryl, stearyl, myristyl and tridecyl esters, mercaptobenzimidazole and the zinc salt of 2-mercaptobenzimidazole, dibutylzinc dithiocarbamate, dioctadecyl disulfide and pentaerythritol tetrakis(β-dodecylmercapto)propionate, 2-hydroxybenzophenones, such as the 4-hydroxy, 4-methoxy, 4-octyloxy, 4-decycloxy, 4-dodecyloxy, 4-benzyloxy, 4,2′,4′-trihydroxy and 2′-hydroxy-4,4′-dimethoxy derivatives, esters of unsubstituted and substituted benzoic acids, such as 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl-3,5-di-tert-butyl-4-hydroxybenzoate, octadecyl-3,5-di-tert-butyl-4-hydroxybenzoate and 2-methyl-4,6-di-tert-butylphenyl-3,5-di-tert-butyl-4-hydroxybenzoate, acrylates, such as ethyl α-cyano-β,β-diphenylacrylate, isooctyl α-cyano-β,β-diphenylacrylate, methyl α-methoxycarbonylcinnamate, methyl α-cyano-β-methyl-p-methoxycinnamate, butyl-α-cyano-β-methyl-p-methoxycinnamate and methyl-α-methoxycarbonyl-p-methoxycinnamate, sterically hindered amines, such as bis(2,2,6,6-tetramethylpiperidin-4-yl)sebacate, bis(2,2,6,6-tetramethylpiperidin-4-yl)succinate, bis(1,2,2,6,6-pentamethylpiperidin-4-yl)sebacate, bis(1-octyloxy-2,2,6,6-tetramethylpiperidin-4-yl) sebacate, bis(1,2,2,6,6-pentamethylpiperidin-4-yl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, the condensation product of N,N′-bis(2,2,6,5-tetramethylpiperidin-4-yl)hexamethylenediamine and 4-tert-octylamino-2,6-dichloro-1,3,5-triazine, tris(2,2,6,6-tetramethylpiperidin-4-yl)nitrilotriacetate, tetrakis(2,2,6,6-tetramethylpiperidin-4-yl) 1,2,3,4-butanetetracarboxylate, 1,1′-(1,2-ethylene)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidin-4-yl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidin-4-yl)sebacate, bis(1-octyloxy-2,2,6,5-tetramethylpiperidin-4-yl)succinate, the condensation product of N,N′-bis(2,2,6,6-tetramethylpiperidin-4-yl)hexamethylenediamine and 4-morpholino-2,6-dichloro-1,3,5-triazine, the condensation product of 2-chloro-4,6-bis(4-n-butylamino-2,2,6,6-tetramethylpiperidin-4-yl)-1,3,5-triazine and 1,2-bis(3-aminopropylamino)ethane, the condensation product of 2-chloro-4,6-di(4-n-butylamino-1,2,2,6,6-pentamethylpiperidin-4-yl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethylpiperidin-4-yl)pyrrolidine-2,5-dione, 3-dodecyl-1-(1,2,2,6,6-pentamethylpiperidin-4-yl)pyrrolidine-2,5-dione, a mixture of 4-hexadecyloxy- and 4-stearyloxy-2,2,6,6-tetramethylpiperidine, the condensation product of N,N′-bis(2,2,6,6-tetramethylpiperidin-4-yl)hexamethylenediamine and 4-cyclohexylamino-2,6-dichloro-1,3,5-triazine, the condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethylpiperidin-4-yl)-n-dodecylsuccinimide, N-(1,2,2,6,6-pentamethylpiperidin-4-yl)-n-dodecylsuccinimide, 2-undecyl-7,7,9,9-tetramethyl-1-oxa-3,8-diaza-4-oxo-spiro[4.5]decane, the condensation product of 7,7,9,9-tetramethyl-2-cycloundecyl-1-oxa-3,8-diaza-4-oxospiro-[4.5]decane and epichlorohydrin, the condensation products of 4-amino-2,2,6,6-tetramethylpiperidine with tetramethylolacetylenediureas and poly(methoxypropyl-3-oxy)-[4(2,2,6,6-tetramethyl)piperidinyl]siloxane, oxamides, such as 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, and mixtures of ortho-, para-methoxy-disubstituted oxanilides and mixtures of ortho- and para-ethoxy-disubstituted oxanilides, and 2-(2-hydroxyphenyl)-1,3,5-triazines, such as 2,4,6-tris-(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methyl-5 phenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropoxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

The components F of the IR absorber used are compounds which exhibit one or more absorption bands in the infrared spectral region, i.e. from >750 nm, e.g. from 751 nm, to 1 mm. Preference is given to compounds which exhibit one absorption band in the near infrared (NIR) spectral region, i.e. from >750 (e.g. 751) to 2000 nm, and optionally additionally also in the visible spectral region, especially from 550 to 750 nm. When the compounds absorb both in the IR and in the visible spectral region, they preferably exhibit the greatest absorption maximum in the IR region and a smaller maximum (frequently in the form of a so-called absorption shoulder) in the visible region. In a particular embodiment, the compounds of component F additionally also exhibit fluorescence. Fluorescence is the transition of a system excited by absorption of electromagnetic radiation (usually visible light, UV radiation, X-rays or electron beams) to a state of lower energy by spontaneous emission of radiation of the same wavelength (resonance fluorescence) or longer wavelength. Preferred compounds of component F exhibit, when they fluoresce, a fluorescence in the IR spectral region, preferably in the NIR.

Such compounds are, for example, selected from naphthalenes, anthracenes, phenanthrenes, tetracenes, perylenes, terrylenes, quaterrylenes, pentarylenes, hexarylenes, anthraquinones, indanthrones, acridines, carbazoles, dibenzofuranes, dinaphthofuranes, benzimidazoles, benzthiazoles, phenazines, dioxazines, quinacridones, metal phthalocyanines, metal naphthalocyanines, metal porphyrines, coumarines, dibenzofuranones, dinaphthofuranones, benzimidazolones, indigo compounds, thioindigo compounds, quinophthalones, naphthoquinophthalones and diketopyrrolopyrroles. Particularly preferred compounds of component F which absorb IR radiation and optionally fluoresce are selected from naphthalenes, anthracenes, phenanthrenes, tetracenes, perylenes, terrylenes, quaterrylenes, pentarylenes and hexarylenes, more preferably from perylenes, terrylenes and quaterrylenes and especially from terrylenes and quaterrylenes. The compound is especially a quaterrylene. Suitable compounds are described in WO 2008/012292, which is hereby fully incorporated by reference.

As explained at the outset, the selective reflection of circular-polarized light of the chiral nematic phase leads to not more than 50% of the incident light with the reflection wavelength being reflected. The rest passes through without interaction with the medium. In order to achieve a maximum reflection, the inventive film therefore comprises, in a preferred embodiment, at least two liquid-crystalline layers in hardened form, which reflect in the infrared wavelength range, the at least two layers forming at least one layer pair in which two reflect a similar wavelength range in the infrared and the two layers of this layer pair differ in their chirality. The inventive film preferably comprises a number of cholesteric (=liquid-crystalline) layers divisible by 2, for example 2, 4, 6, 8 or 10 layers, in which case two layers always form a layer pair in which these layers reflect in a similar wavelength range in the infrared but have opposite chirality.

“Reflect a similar wavelength range in the infrared” means that the pitch of the helical superstructures in these layers is essentially equal. “Essentially equal” means that the pitches in the two layers differ by at most 6%, preferably by at most 3%. The positions of the maxima of the two reflection bands differ by at most 40 nm, preferably by at most 20 nm and especially by at most 10 nm.

In the context of the present invention, the term “layer pair” should not be understood in a restrictive manner and is more particularly not intended to dictate that the two layers which form it are adjacent. The relative position of two layers of this kind within the film is instead essentially uncritical, and the term “layer pair” refers only to the abovementioned conditions for their physical properties (essentially equal pitch; opposite chirality).

When the inventive film comprises more than one cholesteric layer pair as defined above, it is preferred that these further layer pairs each reflect in a different wavelength range in the infrared, i.e. all layer pairs have reflection maxima with different wavelengths in each case. However, all reflection maxima are within the infrared and preferably within the IR regions specified above as preferred.

In an alternatively preferred embodiment of the invention, the inventive film comprises at least a layer pair of two liquid-crystalline layers in hardened form, these two layers each reflecting in a similar wavelength range of the infrared and having the same chirality, and a λ/2 film being present between these two layers. In this embodiment too: when the inventive film comprises more than one cholesteric layer pair as just defined, it is preferred that these further layer pairs each reflect in a different wavelength range in the infrared, i.e. all layer pairs have reflection maxima with different wavelengths in each case. However, all reflection maxima are within the infrared and preferably in the IR regions specified above as preferred. In this connection too, the term “layer pair” shall not be understood in a restrictive manner and is more particularly not intended to dictate that the two layers which form it are adjacent. The relative position of two layers of this kind within the film is instead essentially uncritical, and the term “layer pair” refers only to the abovementioned conditions for their physical properties (essentially equal pitch height; same chirality). In this case, it is, however, preferred that the two layers which together form a layer pair are separated only by the λ/2 film and more particularly are not separated by a further liquid-crystalline layer with a different reflection range and/or chirality. Of course, it is possible, however, for a layer without significant optical properties, for example an alignment layer, to be present between the two layers of the layer pair (apart from the λ/2 film).

When the inventive film comprises layers with different reflection maxima, it is preferred that the layers are built up relative to one another in the sequence of increasing wavelengths, i.e. first comes the layer with the shortest wavelength of the reflection maximum, then that with the second-shortest wavelength of the reflection maximum, etc. When the film comprises two or more layer pairs of layers of equal pitch but opposite chirality and they are not adjacent, the film is preferably built up such that first all layers of one chirality follow one another in the sequence of increasing wavelengths of the reflection maxima, and then all layers of the other chirality, likewise in the sequence of increasing wavelengths of the reflection maxima. For illustration, some examples of preferred sequences of this type are listed below, neglecting optional layers such as carrier film, alignment layer, etc.:

| | |
|---|---|
| RCPL-RL; λ_{R}1 | LCPL-RL; λ_{R}1 |
| LCPL-RL; λ_{R}1 | RCPL-RL; λ_{R}1 |
| RCPL-RL; λ_{R}2 | LCPL-RL; λ_{R}2 |
| LCPL-RL; λ_{R}2 | RCPL-RL; λ_{R}2 |
| RCPL-RL; λ_{R}3 | LCPL-RL; λ_{R}3 |
| LCPL-RL; λ_{R}3 | RCPL-RL; λ_{R}3 |
| etc. | etc. |
| RCPL-RL; λ_{R}1 | LCPL-RL; λ_{R}1 |
| RCPL-RL; λ_{R}2 | LCPL-RL; λ_{R}2 |
| RCPL-RL; λ_{R}3 | LCPL-RL; λ_{R}3 |
| LCPL-RL; λ_{R}1 | RCPL-RL; λ_{R}1 |
| LCPL-RL; λ_{R}2 | RCPL-RL; λ_{R}2 |
| LCPL-RL; λ_{R}3 | RCPL-RL; λ_{R}3 |
| etc. | etc. |
| RCPL-RL; λ_{R}1 | LCPL-RL; λ_{R}1 |
| λ/2 film | λ/2 film |
| RCPL-RL; λ_{R}1 | LCPL-RL; λ_{R}1 |
| RCPL-RL; λ_{R}2 | LCPL-RL; λ_{R}2 |
| λ/2 film | λ/2 film |
| RCPL-RL; λ_{R}2 | LCPL-RL; λ_{R}2 |
| RCPL-RL; λ_{R}3 | LCPL-RL; λ_{R}3 |
| λ/2 film | λ/2 film |
| RCPL-RL; λ_{R}3 | LCPL-RL; λ_{R}3 |
| etc. | etc. |

In these diagrams, RCPL-RL means right-circular-polarized light-reflecting layer and LCPL-RL means left-circular-polarized light-reflecting layer; λ_{R}1 is the shortest wavelength of the reflection maximum, λ_{R}2 is the second-shortest and λ_{R}3 the third-shortest wavelength of the reflection maximum.

When the inventive film also has one or more reflection maxima in the visible wavelength range, it is preferred that the film comprises at least one layer which is a liquid-crystalline layer in hardened form and which reflects in the wavelength range of visible light (layer (f)). Layer (f) may essentially be constructed like layer (a), although the pitches must of course differ. With regard to the suitable composition of such layers, reference is accordingly made to the above remarks regarding layer (a), especially regarding layer (a.1). In the case of layers (f) too, compositions (f.1) are preferred. As already stated, in the case of compositions (f.1), such layers differ from layers with a reflection maximum in the IR range (a.1) by the amount of chiral monomer.

When the inventive film comprises two or more layers which reflect in the wavelength range of visible light, it is preferred that the film does not comprise any layer pairs of layers of the same pitch but of opposite chirality, which reflect in the wavelength range of visible light. The film more preferably comprises only one layer which reflects in the wavelength range of visible light, or a plurality of layers which reflect in the wavelength range of visible light, in which case the layers have either the same chirality and/or different pitches.

For illustration, some examples of preferred sequences in films which comprise a layer which has at least one reflection maximum in the visible wavelength range, are listed below, neglecting optional layers such as carrier film, alignment layer, etc.:

| | |
|---|---|
| RCPL- or LCPL-RL; λ_{R}vis | RCPL- or LCPL-RL; λ_{R}vis |
| RCPL-RL; λ_{R}1 | LCPL-RL; λ_{R}1 |
| LCPL-RL; λ_{R}1 | RCPL-RL; λ_{R}1 |
| RCPL-RL; λ_{R}2 | LCPL-RL; λ_{R}2 |
| LCPL-RL; λ_{R}2 | RCPL-RL; λ_{R}2 |
| RCPL-RL; λ_{R}3 | LCPL-RL; λ_{R}3 |
| LCPL-RL; λ_{R}3 | RCPL-RL; λ_{R}3 |
| etc. | etc. |
| RCPL- or LCPL-RL; λ_{R}vis | RCPL- or LCPL-RL; λ_{R}vis |
| RCPL-RL; λ_{R}1 | LCPL-RL; λ_{R}1 |
| RCPL-RL; λ_{R}2 | LCPL-RL; λ_{R}2 |
| RCPL-RL; λ_{R}3 | LCPL-RL; λ_{R}3 |
| LCPL-RL; λ_{R}1 | RCPL-RL; λ_{R}1 |
| LCPL-RL; λ_{R}2 | RCPL-RL; λ_{R}2 |
| LCPL-RL; λ_{R}3 | RCPL-RL; λ_{R}3 |
| etc. | etc. |
| RCPL- or LCPL-RL; λ_{R}1 | RCPL- or LCPL-RL; λ_{R}1 |
| RCPL-RL; λ_{R}1 | LCPL-RL; λ_{R}1 |
| λ/2-film | λ/2-film |
| RCPL-RL; λ_{R}1 | LCPL-RL; λ_{R}1 |
| RCPL-RL; λ_{R}2 | LCPL-RL; λ_{R}2 |
| λ/2-film | λ/2-film |
| RCPL-RL; λ_{R}2 | LCPL-RL; λ_{R}2 |
| RCPL-RL; λ_{R}3 | LCPL-RL; λ_{R}3 |
| λ/2-film | λ/2-film |
| RCPL-RL; λ_{R}3 | LCPL-RL; λ_{R}3 |
| etc. | etc. |

In these diagrams, RCPL-RL means right-circular-polarized light-reflecting layer and LCPL-RL means left-circular-polarized light-reflecting layer; λ_{R}1 is the shortest wavelength of the reflection maximum, λ_{R}2 is the second-shortest and λ_{R}3 the third-shortest wavelength of the reflection maximum in the IR, and λ_{R} vis is the wavelength of the reflection maximum in the visible spectral region.

When the inventive film comprises a carrier film, the liquid-crystalline layer with the shortest wavelength of the reflection maximum is preferably the closest to the carrier film.

The inventive film optionally comprises at least one carrier film. In a preferred embodiment, it comprises one carrier film. The carrier film may be coated with the remaining layers on one or both sides. With regard to the “film” part of the name, reference is made to the above remarks. The “carrier” part of the name means that the carrier film is not just self-supporting but can also carry the remaining layers without tearing.

Suitable materials from which the carrier film is formed comprise polyethylene terephthalate, polyethylene naphthalate, polyvinyl butyral, polyvinyl chloride, flexible polyvinyl chloride, polymethyl methacrylate, poly(ethylene-co-vinyl acetate), polycarbonate, cellulose triacetate, polyether sulfone, polyester, polyamide, polyolefins and acrylic resins. Among these, polyethylene terephthalate, polyvinyl butyral, polyvinyl chloride, flexible polyvinyl chloride and polymethyl methacrylate are preferred.

The carrier film is preferably biaxially oriented.

In a preferred embodiment, the inventive film comprises at least one carrier film, more preferably one or two carrier films, and at least one, preferably one, of these carrier films is an adhesion film. The adhesion film preferably constitutes the outermost or second-from-outermost layer of the inventive film, in which latter case the outermost film is a protective film which prevents the undesired adhesion of the adhesion film to the environment until the desired time. The adhesive side of the film is of course directed outward, i.e. in the opposite direction to the rest of the film layers. The adhesion film is preferably configured such that it can adhere to polar surfaces without adhesive. Polar surfaces are, for example, glass or plastic.

The adhesive-free adhesion to polar surfaces is ensured firstly through the selection of a suitable material. Suitable materials are thermoplastics, especially thermoplastic polyolefins, flexible PVC and polymethyl methacrylate (PMMA). While flexible PVC and PMMA are polar and hence inherently possess the required property for adhesion to polar surfaces, polyolefins which are inherently nonpolar first have to be polarized by a surface activation, such as flaming, plasma treatment or corona treatment, in order that they receive adhesive properties.

However, the adhesion is increased when at least the surface roughness of that side of the film which is to have adhesive action is very low and, for example, has a value R^{a} of not more than 5 μm, for example of from 0.05 to 5 μm, preferably of not more than 3 μm, for example from 0.05 to 3 μm, more preferably of not more than 1 μm, for example from 0.05 to 1 μm, even more preferably of not more than 0.5 μm, for example from 0.05 to 0.5 μm, and especially of not more than 0.25 μm, for example from 0.05 to 0.25 μm. The opposite side may have a significantly higher roughness, for example a roughness R^{a} greater by a factor of 1.5 or 2 or 5 or 10 or 100.

The protective film which may optionally be arranged above the adhesion film is suitably likewise composed of a polar or polarized thermoplastic polymeric material. In addition to the aforementioned thermoplastics, especially polyesters are also suitable.

Such adhesion films and protective films suitable therefor and processes for producing them are described, for example, in DE-A-102006017881, which is hereby fully incorporated by reference.

In an alternatively preferred embodiment, the at least one carrier film comprises at least one decorative film. The decorative film may replace one carrier film or all carrier films and/or one adhesion film or all adhesion films, or constitute an additional layer within the inventive film.

The decorative film is suitably formed from a transparent thermoplastic as a base material; suitable plastics are all of those mentioned above for the carrier film and the adhesion film. For decorative purposes, the decorative film has pigmentation, a pattern, a print, a profile and/or an embossed structure, so as to give rise, for example, to a 3D effect. When the decorative film is configured as an adhesion film, pigmentation, pattern and print are preferably present on the side which is not adhesive. Suitable polymers, pigments and dyes, and suitable processes for dyeing, printing, profiling and embossing the decorative film, are described, for example, in DE-A-102006017881 and in DE-A-10100692, which are hereby fully incorporated by reference.

In a preferred embodiment, the inventive film comprises at least one alignment layer. In the case that the inventive film comprises at least one carrier film, the at least one alignment layer is preferably arranged between the at least one carrier film and the at least one liquid-crystalline layer and/or between at least two liquid-crystalline layers. When the inventive film does not comprise a carrier film, the at least one alignment layer is preferably arranged between at least two liquid-crystalline layers.

Alignment layers serve to improve the homogeneously planar alignment of the liquid-crystalline layer such that the liquid-crystalline layer is present as far as possible as a monodomain. This is because multidomains lead to light scattering in all directions and give the layer a cloudy appearance.

Alignment layers are typically formed from polymer films which, before the application of the cholesteric layer, are mechanically rubbed unidirectionally such that the directors of the liquid-crystalline molecules align in the direction of rubbing.

Suitable polymers are, for example, polyimides and polyvinyl alcohol. Also suitable are photoalignment materials (LPP=linearly photopolymerizable polymer), for example from Rolic or Chisso. Also suitable are inorganic alignment layers, such as silicon dioxide, which are applied by cathode atomization or biased vapor deposition.

However, the alignment layers are preferably selected from polyimides, for example of the Sunever® brand from Nissan or from JSR, or polyvinyl alcohol, greater preference being given to polyimides. Polyimides are typically applied in the form of the corresponding polyamide acid and then hardened thermally, for example, to give the polyimide.

In a further preferred embodiment, the inventive film comprises at least one layer which absorbs IR radiation.

The IR-absorbing layer preferably comprises at least one of the IR-reflecting substances described as component F. These are either applied as such, for example by application of a solution or suspension in which they are dissolved or dispersed, and evaporation of the solvent, or preferably embedded in a carrier film, especially in a polyvinyl butyral carrier film.

In a further preferred embodiment, the inventive film comprises at least one protective layer, adhesive layer and/or release layer.

With regard to protective layers for the adhesive side of an adhesive film, reference is made to the above remarks regarding the protective film for adhesive films.

Suitable protective layers (topcoats) which are applied to a liquid-crystalline layer are, for example, those based on polyurethane, polyesterurethane, polyesteracrylate or nitrocellulose coating material. The protective layer is preferably photochemically crosslinkable when the cholesteric layer is hardened photochemically. In this case, the cholesteric layer is more preferably not polymerized fully, such that the subsequent crosslinking of the protective layer crosslinks a portion of the cholesteric layer to the protective layer. The topcoat preferably has a layer thickness of at least 5 μm, more preferably of at least 10 μm. The topcoat preferably comprises a light-stabilizing active ingredient (see component E above). Suitable protective layers are obtained, for example, with the Laromer® brands from BASF SE.

Suitable adhesive layers are produced, for example, through the use of the above-described adhesion promoters. The adhesive layer preferably constitutes one of the outermost layers of the inventive film. When the inventive film comprises an adhesive layer, it is preferably also provided with a release layer in order to prevent undesired adhesion of the film, and thus constitutes one of the second-from-outermost layers of the inventive film.

The inventive film can be produced by customary prior art processes for producing coated films. To this end, a carrier film is generally provided and is provided with the desired layers in the desired sequence. The liquid-crystalline layers can be hardened after each application or else coated wet on wet with the further layers. However, preference is given to at least partially hardening each liquid-crystalline layer after application before the next layer is applied. It is also possible to coat two carrier films separately and then to adhesive-bond them. If desired, one or both carrier films can then be detached from this adhesive-bonded film, and the film sides can be coated with further layers and/or adhesive-bonded to further films until the desired film composition has been attained. If the inventive film is not to comprise a carrier film, it is removed on completion of coating/adhesive bonding.

One embodiment of a process for producing the inventive film comprises the following steps:
(I) providing a carrier film and optionally cleaning and/or generating a preferential direction on the film surface;
(II) optionally: applying an alignment layer to the carrier film and optionally cleaning and/or generating a preferential direction on the alignment layer;
(III) optionally applying a composition (f.1), (f.2), (f.3), (f.4) or (f.5), optionally aligning, and at least partially hardening the composition;
(IV) optionally: applying an alignment layer to the layer obtained in step (III) and optionally cleaning and/or generating a preferential direction on the alignment layer;
(V) applying a composition (a.1), (a.2), (a.3), (a.4) or (a.5), optionally aligning, and at least partially hardening the composition;
(VI) optionally: applying an alignment layer to the layer obtained in step (V) and optionally cleaning and/or generating a preferential direction on the alignment layer;
(VII.1) optionally: applying a composition (a.1), (a.2), (a.3), (a.4) or (a.5) to the film obtained in step (V) or (VI) (layer side or carrier film side), optionally aligning, and at least partially hardening the composition; the layer obtained in step (VII.1) differing from the layer obtained in step (V) in terms of chirality and/or the reflected IR wavelength range; or
(VII.2) optionally: applying a λ/2 film to the layer obtained in step (V) and then applying the same composition as in step (V) to the λ/2 film, optionally aligning, and at least partially hardening the composition;
(VIII) optionally: single or multiple repetition of steps (II) to (VII), the repetitions using compositions which differ from compositions of the previous steps (V) and (VII) and optionally also (III);
(IX) optionally: adhesive bonding of two films obtained in step (V), (VII) and/or (VIII);
(X) optionally: detaching one or both carrier films from the adhesive-bonded film obtained in step (IX);
(XI) optionally: single or multiple repetition of steps (IX) and (X); and
(XII) optionally: applying a protective layer, an adhesive layer and/or a release layer to the layer obtained in step (V), (VII), (VIII), (X) or (XI).

The carrier film can be cleaned in step (I) by means of common methods, such as ultrasound, adhesive rolling, for example with a Teknek roll, rubbing, for example with velvet, blowing with dry filtered air, blowing with ionized air or nitrogen, atomization etching or sputtering etching with argon or reactive gases under reduced pressure (plasma methods), plasma methods under atmospheric pressure, corona methods, UV and/or ozone treatments.

A preferential direction is generated on the film surface, for example, by stretching the carrier film and/or by single or multiple unidirectional rubbing with velvet or microfiber tissues. Alternatively or additionally, a preferential direction is generated on the film surface chemically by applying an alignment layer (step II), which is in turn purified like the carrier film and/or provided with a preferential direction.

The method by which the alignment layer is suitably applied to the carrier film in step (II) or to an at least partially hardened liquid-crystalline layer depends greatly on the substances which are to constitute the alignment layer. For example, to generate a polyamide alignment layer, as already mentioned, the corresponding polyamide acid is applied and then hardened, which can, for example, be done thermally by heating. The polyamide acid or the polyvinyl alcohol, which is also suitable for producing alignment layers, is applied, for example, as a solution or suspension and freed of the solvent. Inorganic layers such as silicon dioxide are obtained by specific processes, such as cathode atomization or biased vapor deposition.

The compositions (a.1), (a.2), (a.3), (a.4) or (a.5) and optionally (f.1), (f.2), (f.3), (f.4) or (f.5) are generally used in the form of a solution or an aqueous suspension or emulsion. They are generally applied by means of customary methods, for example by means of methods which are selected from airknife-coating, knife-coating, airblade-coating, squeeze-coating, impregnation-coating, reverse roll-coating, transfer roll-coating, gravure-coating, kiss-coating, cast-coating, spray-coating, spin-coating, or printing methods such as relief printing, gravure printing, flexographic printing, offset printing, inkjet printing, letterpress printing, pad printing, heatseal printing or screenprinting methods.

The cholesteric layer is generally aligned spontaneously during the application operation; however, it can also be aligned in a subsequent step. In this case, the alignment is effected by means of the known methods, for example interaction of the liquid-crystalline phase with alignment layers, the application of electrical or magnetic fields or the mechanical knife-coating of the liquid-crystal layers. However, the alignment preferably proceeds spontaneously under the action of the shear forces acting in the course of application.

Subsequently, the cholesteric layer applied can be dried by means of customary methods, for example with hot air.

The cholesteric layer can be polymerized thermally, by means of electron beams or preferably photochemically.

The application of the alignment layer in step (II) and the application of the composition (a) or (f) to the alignment layer or directly to the carrier film in step (II) can be effected on only one side or else on both sides of the carrier film. When the film is coated on both sides, this can be done simultaneously or preferably successively. In the case of successive double-sided coating, the second side of the carrier film is not coated until the coating of the first side is complete.

Another embodiment of a process for producing an inventive thermally insulating film comprises the following steps:
(i) providing a film according to the invention as defined above;
(ii) if the film has been concluded by a carrier film or a protective film on both sides, detaching one of the carrier films or the protective film;
(iii) applying the film provided in step (i) or (ii) to a new carrier film; and
(iv) transferring the layers to the new film.

The transfer is generally effected by means of pressure and/or elevated temperature. After the transfer, any carrier film still present from the film used in step (i) can be detached if desired and optionally replaced by a protective layer.

Before the application in step (iii), the layer which is to come into contact with the new film and/or the new film can be provided with an adhesion promoter. Suitable adhesion promoters are specified above.

This transfer method is an option especially when the carrier film in the end product is to be polyvinyl butyral; i.e. the new film used in step (iii) is preferably polyvinyl butyral. Accordingly, the carrier film which is optionally present in the film provided in step (i) is not a polyvinyl butyral film. This so-called transfer film is preferably selected from polyethylene, polyethylene terephthalate and polypropylene films. The transfer film is especially a polyethylene terephthalate film.

The invention further provides a thermally insulating laminate comprising

(1) at least one liquid-crystalline layer in hardened form, as defined above;

(2) optionally at least one carrier material;

(3) optionally at least one alignment layer;

(4) optionally at least one λ/2 film; and

(5) optionally at least one protective layer, adhesive layer and/or release layer;

where, in the case that none of components (2) to (5) is present, component (1) comprises at least two liquid-crystalline layers in hardened form.

The difference between the inventive film and the inventive laminate consists essentially in the flexibility. While the film possesses such a flexibility that it can be rolled up without fracturing, this is no longer the case for the laminate owing to its greater stiffness.

The inventive laminate preferably comprises at least one carrier material. Preferred carrier materials are selected from glass, transparent polymers, composite systems composed of glass and transparent polymers, nontransparent polymers, metal, ceramic and clay.

Useful glasses include window or exterior glass, composite glass, insulation glass, safety glass or mixed systems.

The transparent polymers may include all polymers listed for the carrier film, though they differ from the carrier film by their greater thickness. Preference is given to polycarbonate.

With regard to the remaining layers (1) and (3) to (5), reference is made to the remarks regarding the film.

The inventive laminates can in principle be produced analogously to the inventive films. Thus, a carrier material is generally provided and coated with the desired layers in the desired sequence.

One embodiment of a process for producing the inventive laminate comprises the following steps:
(1) providing a carrier film and optionally cleaning and/or generating a preferential direction on the material surface;
(2) optionally: applying an alignment layer to the carrier film and optionally cleaning and/or generating a preferential direction on the alignment layer;
(3) optionally applying a composition (f.1), (f.2), (f.3), (f.4) or (f.5), optionally aligning, and at least partially hardening the composition;
(4) optionally: applying an alignment layer to the layer obtained in step (3) and optionally cleaning and/or generating a preferential direction on the alignment layer;
(5) applying a composition (a.1), (a.2), (a.3), (a.4) or (a.5), optionally aligning, and at least partially hardening the composition;
(6) optionally: applying an alignment layer to the layer obtained in step (5) and optionally cleaning and/or generating a preferential direction on the alignment layer;
(7.1) optionally: applying a composition (a.1), (a.2), (a.3), (a.4) or (a.5) to the coating obtained in step (5) or (6), optionally aligning, and at least partially hardening the composition; the layer obtained in step (7.1) differing from the layer obtained in step (5) in terms of chirality and/or the reflected IR wavelength range; or
(7.2) optionally: applying a λ/2 film to the layer obtained in step (5) and then applying the same composition as in step (5) to the λ/2 film, optionally aligning, and at least partially hardening the composition;
(8) optionally: single or multiple repetition of steps (2) to (7), the repetitions using compositions which differ from compositions of the previous steps (5) and (7) and optionally also (3);
(9) optionally: adhesive bonding of two laminates obtained in step (5), (7) and/or (8);
(10) optionally: applying a protective layer, an adhesive layer and/or a release layer to the layer obtained in step (5), (7) or (8).

With regard to suitable configurations of the individual layers, reference is made to the above production method for the inventive film. It should be mentioned merely that suitable cleaning steps (1), especially for glass as a carrier material, also comprise washing in water or surfactant-containing baths.

Possible and also very suitable for the production of the inventive laminate are additionally transfer methods which preferably comprise the following steps:
(i) providing an inventive film as defined above;
(ii) if the film has been concluded by a carrier film or a protective film on both sides, detaching one of the carrier films or the protective film;
(iii) applying the film provided in step (i) or (ii) to a carrier material; and
(iv) transferring the layers to the carrier material.

Regarding the individual steps, the statements made above apply analogously.

The invention further provides a composition comprising the compound of the formula IV.c and at least one achiral nematic polymerizable monomer. With regard to suitable achiral nematic polymerizable monomers, reference is made to the above remarks.

In a preferred embodiment, the inventive composition comprises the compound of the formula IV.c and the compound of the formula I.a. In an alternatively preferred embodiment, the inventive composition comprises the compound of the formula IV.c and the compound of the formula I.b. In an alternatively preferred embodiment, the inventive composition comprises the compound of the formula IV.c, the compound of the formula I.a and the compound of the formula I.b.

The invention further provides for the use of the inventive film or of the inventive film or of the inventive composition for heat management of constructions and means of transport.

In this connection, “heat management” is understood to mean the screening of constructions and means of transport from thermal radiation.

Constructions are understood to mean buildings and parts of buildings and all kinds of architectural constructions, for example domestic, commercial and industrial buildings, roofs, windows, exterior walls, couple layers of such buildings, roofs or walls not joined to a building, for example stadium walls and roofs, bridge walls and roofs, walls and roofs of covered paths and passages, walls and roofs of shelters, for example at stopping places or stations and the like. The means of transport are all possible means of transport and parts thereof which are to be protected against the influence of heat, such as passenger vehicles (automobiles) and parts thereof, especially back, front and side windows (glass), roof, sliding roof (glass or metal), engine hood (metal), trucks and parts thereof (as also for passenger vehicles), trains, aircraft, ships and the like. The use of the inventive film or of the inventive composition for the heat management of helmets, for example motorcycle helmets, forms part of the subject matter of the invention.

The examples which follow are intended to illustrate the invention in detail but without restricting it.

### EXAMPLES

1.) Formulations

The following formulations were prepared:

All formulations comprised cyclopentanone and methyl isobutyl ketone in a weight ratio of 8:2 as the solvent. They additionally comprised 0.05% by weight of Tego Rad 2100 as a leveling aid and 1% by weight of Lucirin TPO as a photoinitiator, based in each case on the total amount (=100%) of nematic and chiral compounds.

Formulation A (Right-Twisting):

Compound of the Formula I.b

Compound of the formula IV.a in an amount of 3.1% by weight, based on the weight of compound I.b

Formulation B (Right-Twisting):

Compound of the Formula I.b

Compound of the formula IV.a in an amount of 2.6% by weight, based on the weight of compound I.b

Formulation C (Right-Twisting):

Compound of the Formula I.b

Compound of the formula IV.a in an amount of 2.0% by weight, based on the weight of compound I.b

Formulation D (Left-Twisting):

Compound of the Formula I.b

Compound of the formula IV.c in an amount of 8.1% by weight, based on the weight of compound I.b

Formulation E (Left-Twisting):

Compound of the Formula I.b

Compound of the formula IV.c in an amount of 6.7% by weight, based on the weight of compound I.b

Formulation F (Left-Twisting):

Compound of the Formula I.b

Compound of the formula IV.c in an amount of 5.0% by weight, based on the weight of compound I.b

Formulation G (Right-Twisting):

Compound of the Formula I.a

Compound of the formula IV.a in an amount of 2.8% by weight, based on the weight of compound I.a

Formulation H (Left-Twisting):

Compound of the Formula I.a

Compound of the formula IV.c in an amount of 10.7% by weight, based on the weight of compound I.a

Formulation I (Right-Twisting):

Compound of the Formula I.b

Compound of the formula IV.a in an amount of 5.48% by weight, based on the weight of compound I.b

Formulation J (Right-Twisting):

Compound of the Formula I.b

Compound of the formula IV.a in an amount of 4.68% by weight, based on the weight of compound I.b

Formulation K (Left-Twisting):

Compound of the Formula I.b

Compound of the formula IV.c in an amount of 13.32% by weight, based on the weight of compound I.b

Formulation L (Left-Twisting):

Compound of the Formula I.b

Compound of the formula IV.c in an amount of 1.38% by weight, based on the weight of compound I.b

2.) Production of Films—Single Plies

A polyethylene terephthalate film (carrier film) was coated in each case with the abovementioned formulations by means of a gravure roll (film thickness approx. 4 μm), dried in a drying tunnel at 100, 115 and 2×120° C. (formulations A to F and I to L) or 4×90° C. (formulations G and H), and hardened by means of UV light (451 mW/cm²).

The reflection maxima of films A and D were at 1020 nm, those of films B and E at 1230 nm, those of films C and F at 1590 nm, those of films G and H at 930 nm, those of films I and K at 600 nm and those of films J and L at 700 nm.

3.) Production of Films—Multiple Plies

The multi-ply films were obtained by adhesive bonding of the single plies, delamination of the uppermost carrier film, etc. Multi-ply films based on the following formulation were produced in the layer sequence specified:

Film I:

G-A-B-H-A-B

Film II:

A-B-C-D-E-F

Film III:

G-A-B-C-H-D-E-F

Film IV:

I-A-B-C-D-E-F

Film V:

K-A-B-C-D-E-F

4.) Measurement of the Transmission Spectra

The transmission was measured in the wavelength spectrum of sunlight (300 to 2500 nm; Tₛₒₗₐᵣ) to ISO 9050. Analogously, the transmission was determined in the visible wavelength range (Tᵥᵢₛ) and in the IR spectral range with a wavelength from 780 to 1700 nm (T_{IR}). The results are listed in the table below.

TABLE

| Film | Film I | Film II | Film III |
|---|---|---|---|
| Tᵥᵢₛ [%] | 87 | 86 | 86 |
| Tₛₒₗₐᵣ [%] | 58 | 57 | 51 |
| T_{IR} [%] | 45 | 45 | 37 |

1. A thermally insulating film, comprising
(a) at least one liquid-crystalline layer in hardened form, which reflects in a wavelength range of infrared and is obtained by hardening
(a.1) a composition comprising at least one achiral nematic polymerizable monomer and at least one chiral polymerizable monomer; or
(a.2) a composition comprising at least one cholesteric polymerizable monomer; or
(a.3) a composition comprising at least one cholesteric crosslinkable polymer; or
(a.4) a composition comprising at least one cholesteric polymer in a polymerizable diluent; or
(a.5) a mixture of at least two of these compositions;
(b) optionally, at least one carrier film;
(c) optionally, at least one alignment layer which is in contact with the at least one liquid-crystalline layer;
(d) optionally, at least one λ/2 film;
(e) optionally, at least one adhesive layer, protective layer, and/or release layer.

2. The thermally insulating film according to claim 1, which, within a wavelength range from 751 to 2000 nm, reflects at least 40% of the incident radiation.

3. The thermally insulating film according to claim 1, which, within a wavelength range from 390 to 750 nm, has a transmission of at least 80% of the incident radiation.

4. The thermally insulating film according to claim 1, which has at least one maximum of a reflection band in a wavelength range from 390 to 750 nm.

5. The thermally insulating film according to claim 1, further comprising
(f) at least one liquid-crystalline layer in hardened form, which reflects in the wavelength range of from 350 to 750 nm and is obtained by hardening
(f.1) a composition comprising at least one achiral nematic polymerizable monomer and at least one chiral polymerizable monomer; or
(f.2) a composition comprising at least one cholesteric polymerizable monomer; or
(f.3) a composition comprising at least one cholesteric crosslinkable polymer; or
(f.4) a composition comprising at least one cholesteric polymer in a polymerizable diluent; or
(f.5) a mixture of at least two of these compositions.

6. The thermally insulating film according to claim 1, wherein the liquid-crystalline layer (a) in hardened form is a hardened composition (a.1).

7. The thermally insulating film according to claim 4, wherein the liquid-crystalline layer (f) in hardened form is a hardened composition (f.1).

8. The thermally insulating film according to claim 1, wherein the composition (a.1) is hardened and the at least one achiral nematic polymerizable monomer comprises
(i) at least one difunctionally polymerizable achiral nematic monomer of formula (I):
Z¹—(Y¹-A¹)ᵥY²-M-Y³-(A²-Y⁴)_{w}—Z² (I),
wherein
Z¹ and Z² are an identical or different reactive group through which polymerization can be effected, or radicals which comprise the reactive group, wherein, the reactive group is selected from the group consisting of a C═C double bond, a C≡C triple bond, oxirane, thiirane, azirane, cyanate, thiocyanate, isocyanate, carboxylic acid, a hydroxyl group, and an amino group;
Y¹, Y², Y³, Y⁴ are each independently a chemical bond, —O—, —S—, —CO—O—, —O—CO—, —O—CO—O—, —CO—S—, —S—CO—, —CO—N(R^{a})—, —N(R³)—CO—, —N(R^{a})—CO—O—, —O—CO—N(R^{a})—CO—N(R^{a})—, —CH₂—O—, or —O—CH₂,
wherein R^{a} is hydrogen or C₁-C₄-alkyl;
A¹ and A² are identical or different spacers which are linear C₂-C₃₀-alkylene groups, which are optionally interrupted by oxygen, sulfur, and/or optionally monosubstituted nitrogen, wherein these interrupting groups must not be adjacent; a substituent of the monosubstituted nitrogen is a C₁-C₄-alkyl group with its alkylene chain optionally substituted by fluorine, chlorine, bromine, cyano, methyl, or ethyl;
v and w are each independently 0, 1 or 2;
M is a mesogenic group of formula (II):
(T¹-Y⁵)_{y}-T² (II),
wherein
each T¹ and T² are independently a divalent alicyclic, saturated, or partially unsaturated heterocyclic, aromatic, or heteroaromatic radical;
Y⁵ is an identical or different bridging member —CO—O—, —O—CO—, —CH₂—O—, —O—CH₂—, —CO—S—, —S—CO—, —CH₂—S—, —S—CH₂, —CH═N—, —N═CH—, —CH═N—N═CH—, —C≡C—, —CH═CH—, —C(CH₃)═CH₂, —CH═CH(CH₃)— or a direct bond, and
y is 0, 1, 2, or 3; and
(ii) optionally, at least one monofunctionally polymerizable achiral nematic monomer of formula (IIIa) or (IIIb)
A³-Y²-M-Y³-(A²-Y⁴)_{w}—Z² (IIIa),
Z¹—(Y¹-A¹)ᵥ-Y²-M-Y³-A³ (IIIb),
in which Z¹, A¹, Y¹, Y², Y³, Y⁴, v, w and M are each independently as defined for formula (I); and
A³ is a linear C₁-C₃₀-alkyl group, which is optionally interrupted by oxygen, sulfur, and/or optionally monosubstituted nitrogen, wherein these interrupting groups must not be adjacent; a substituent of the monosubstituted nitrogen is a C₁-C₄-alkyl group with its alkyl group optionally substituted by fluorine, chlorine, bromine, cyano, methyl, or ethyl, or is CN or —N═C═S;
and
the at least one chiral polymerizable monomer has formula (IV):
[(Z¹—Y¹)ₒ-A⁴-Y²-M-Y³]ₙX[Y³-M-Y²-A⁵-(Y¹—Z¹)ₚ]ₘ (IV),
wherein
Z¹, Y¹, Y², Y³ and M are each as defined above;
o and p are each 0 or 1, but o and p are not both 0,
A⁴ and A⁵ are the same or different; and
A⁴ is as defined for A¹ when o=1; or,
when o=0, is a linear C₁-C₃₀-alkyl group, which is optionally interrupted by oxygen, sulfur, and/or optionally monosubstituted nitrogen, wherein these interrupting groups must not be adjacent; a substituent of the monosubstituted nitrogen is a C₁-C₄-alkyl group optionally substituted by fluorine, chlorine, bromine, cyano, methyl or ethyl;
A⁵ is as defined for A¹ when p=1; or,
when p=0, is a linear C₁-C₃₀-alkyl group, which is optionally interrupted by oxygen, sulfur, and/or optionally monosubstituted nitrogen, wherein these interrupting groups must not be adjacent; a substituent of the monosubstituted nitrogen is a C₁-C₄-alkyl group optionally substituted by fluorine, chlorine, bromine, cyano, methyl, or ethyl;
n and m are each 0, 1 or 2, where the sum of n+m is 1 or 2; and
X is a chiral radical.

9. The thermally insulating film according to claim 8, wherein T¹ has a structure: 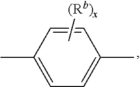
wherein
R^{b} is fluorine, chlorine, bromine, C₁-C₂₀-alkyl, C₁-C₁₀-alkoxy, C₁-C₁₀-alkylcarbonyl, C₁-C₁₀-alkylcarbonyloxy, C₁-C₁₀-alkoxycarbonyl, hydroxyl, nitro, CHO, or CN, and
x is 0, 1, 2, 3, or 4.

10. The thermally insulating film according to claim 8, wherein T² is: 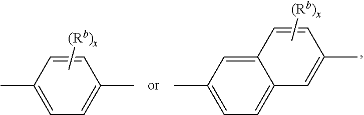
wherein
R^{b} is fluorine, chlorine, bromine, C₁-C₂₀-alkyl, C₁-C₁₀-alkoxy, C₁-C₁₀-alkylcarbonyl, C₁-C₁₀-alkylcarbonyloxy, C₁-C₁₀-alkoxycarbonyl, hydroxyl, nitro, CHO, or CN, and
x is 0, 1, 2, 3, or 4.

11. The thermally insulating film according to claim 8, wherein X is

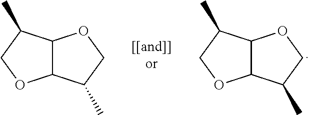

12. The thermally insulating film according to claim 8, wherein the at least one difunctionally polymerizable achiral nematic monomer is at least one selected from the group consisting of a compound of formula (I.a): 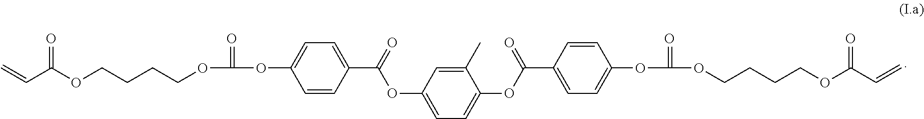
and a compound of formula (I.b):

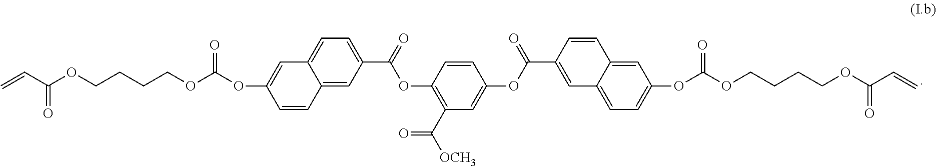

13. The thermally insulating film according to claim 8, wherein the at least one chiral polymerizable monomer is at least one selected from the group consisting of a compound of formula (IV.a): 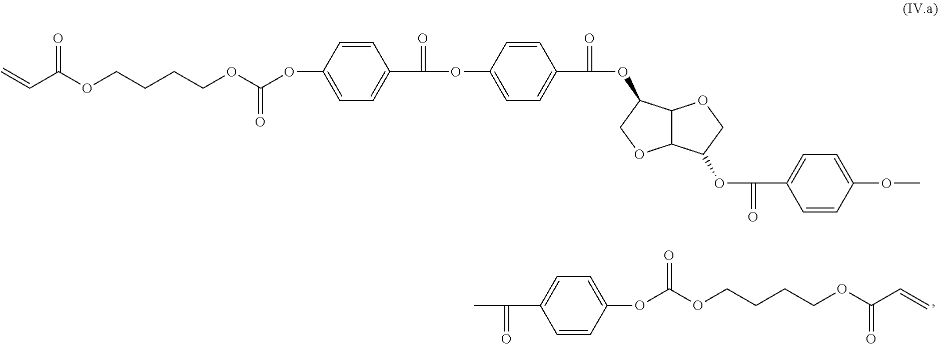
a compound of formula (IV.b) 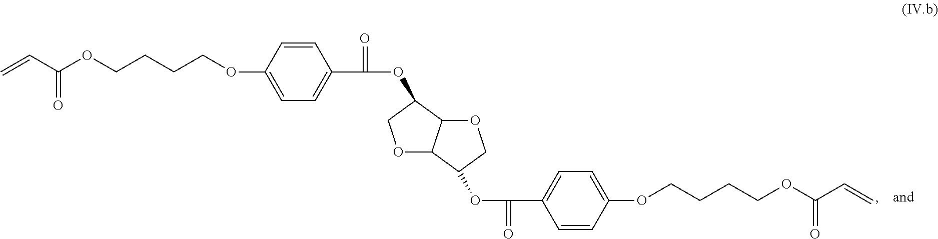
a compound of formula (IV.c)

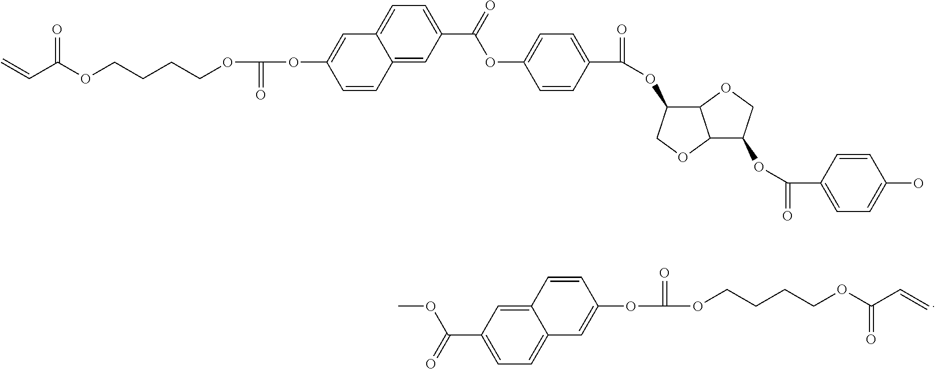

14. The thermally insulating film according to claim 13, wherein the at least one liquid-crystalline layer is obtained from the composition (a.1) or a composition (f.1) which comprises the compound of formula (IV.c) as the chiral polymerizable monomer wherein when the at least one liquid-crystalline layer is obtained from the composition (f.1), the thermally insulating film further comprises:
(f) at least one liquid-crystalline layer in hardened form, which reflects in the wavelength range of from 350 to 750 nm and is by hardening
(f.1) a composition comprising at least one achiral nematic polymerizable monomer and at least one chiral polymerizable monomer.

15. The thermally insulating film according to claim 1, comprising at least two liquid-crystalline layers in hardened form, which reflect in a wavelength range of infrared, said at least two layers comprising at least one layer pair, the two layers in this layer pair reflecting a similar wavelength range of infrared and the two layers of this layer pair differing in their chirality.

16. The thermally insulating film according to any claim 1, comprising at least two liquid-crystalline layers in hardened form, at least two layers each reflecting in different wavelength ranges of infrared.

17. The thermally insulating film according to claim 15, comprising at least two layer pairs, the two layers in these layer pairs reflecting a similar wavelength range of the infrared but differing in their chirality, and the layers in the different layer pairs each reflecting in different wavelength ranges of infrared.

18. The thermally insulating film according to claim 1, comprising at least one layer pair of two liquid-crystalline layers in hardened form, these two layers each reflecting in a similar wavelength range of infrared and having the same chirality, and a λ/2 film being present between these two layers.

19. The thermally insulating film according to claim 1, wherein the at least one carrier film is present and is selected from the group consisting of a polyethylene terephthalate film, a polyethylene naphthalate film, a polyvinyl butyral film, a polyvinyl chloride film, a flexible polyvinyl chloride film, a polymethyl methacrylate film, a poly(ethylene-co-vinyl acetate) film, a polycarbonate film, a cellulose triacetate film, a polyether sulfone film, a polyester film, a polyamide film, a polyolefin film, and an acrylic resin film.

20. The thermally insulating film according to claim 1, wherein the at least one carrier film is present and is in direct or indirect contact with the at least one liquid-crystalline layer on one side or both sides.

21. The thermally insulating film according to claim 1, wherein the at least one alignment layer is present between the at least one carrier film, which is present, and the at least one liquid-crystalline layer, and/or between at least two liquid-crystalline layers.

22. The thermally insulating film according to claim 1, wherein the at least one alignment layer is present and is selected from the group consisting of polyvinyl alcohol and a polyimide.

23. The thermally insulating film according claim 1, wherein the at least one carrier film is present and comprises at least one adhesion film which adheres to polar surfaces without adhesive.

24. The thermally insulating film according to claim 23, wherein the adhesion film comprises flexible polyvinyl chloride, a self-adhesive thermoplastic polyolefin, or polymethyl methacrylate.

25. The thermally insulating film according to claim 1, wherein the at least one carrier film is present and comprises at least one decorative film.

26. The thermally insulating film according to claim 1, comprising the at least one protective layer, adhesive layer, and/or release layer.

27. A thermally insulating laminate, comprising (1) at least one liquid-crystalline layer in hardened form,
which reflects in a wavelength range of infrared and is obtained by hardening
(1a) a composition comprising at least one achiral nematic polymerizable monomer and at least one chiral polymerizable monomer; or
(1b) a composition comprising at least one cholesteric polymerizable monomer; or
(1c) a composition comprising at least one cholesteric crosslinkable polymer; or
(1d) a composition comprising at least one cholesteric polymer in a polymerizable diluent; or
(1e) a mixture of at least two of these compositions;
(2) optionally, at least one carrier material;
(3) optionally, at least one alignment layer;
(4) optionally, at least one λ/2 film; and
(5) optionally, at least one protective layer, adhesive layer, and/or release layer;
wherein, in the case that none of components (2) to (5) is present, component (1) comprises at least two liquid-crystalline layers in hardened form.

28. The thermally insulating laminate according to claim 27, wherein the carrier material is present and is selected from the group consisting of glass, a transparent polymer, a composite system comprising glass and at least one transparent polymer, a nontransparent polymer, a metal, a ceramic, and clay.

29. The thermally insulating laminate according to claim 28, wherein the glass is present and is window glass or exterior glass, composite glass, insulation glass, safety glass, or a mixed system.

30. A pigment, obtained by:
if present, removing the at least one carrier film from remaining layers of the thermally insulating film of claim 1, and
comminuting the layers which have, if it was present, been freed of the at least one carrier film.

31. A composition, comprising a compound of formula (IV.c): 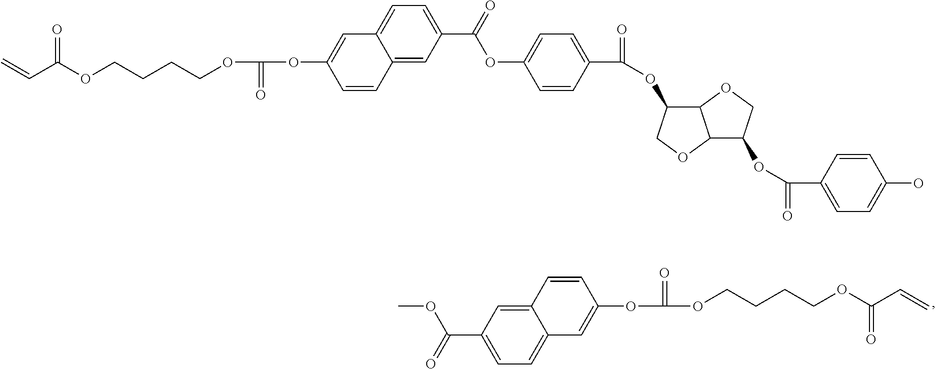
and at least one achiral nematic polymerizable monomer.

32. A process for producing the thermally insulating film of claim 5, the process comprising:
(I) providing a carrier film and optionally cleaning and/or generating a preferential direction on a surface of the carrier film;
(II) optionally, applying an alignment layer to the carrier film and optionally cleaning and/or generating a preferential direction on the alignment layer;
(III) optionally, applying the composition (f.1), (f.2), (f.3), (f.4) or (f.5), optionally aligning, and at least partially hardening the composition;
(IV) optionally, applying an alignment layer to the layer obtained in (III) and optionally cleaning and/or generating a preferential direction on the alignment layer;
(V) applying the composition (a.1), (a.2), (a.3), (a.4) or (a.5), optionally aligning, and at least partially hardening the composition;
(VI) optionally, applying an alignment layer to the layer obtained in (V) and optionally cleaning and/or generating a preferential direction on the alignment layer;
(VII.1) optionally, applying the composition (a.1), (a.2), (a.3), (a.4) or (a.5) to the film obtained in (V) or (VI) on a layer side or carrier film side, optionally aligning, and at least partially hardening the composition; wherein the layer obtained in (VII.1) differs from the layer obtained in (V) in terms of chirality and/or reflected IR wavelength range; or
(VII.2) optionally, applying a λ/2 film to the layer obtained in (V) and then applying the same composition as in (V) to the λ/2 film, optionally aligning, and at least partially hardening the composition;
(VIII) optionally, single or multiple repetition of (II) to (VII), the repetitions employing compositions which differ from compositions of the previous (V) and (VII) and optionally also (III);
(IX) optionally, adhesive bonding of two films obtained in (V), (VII) and/or (VIII) to give an adhesively bonded film;
(X) optionally, detaching one or both carrier films from the adhesive-bonded film obtained in step (IX);
(XI) optionally, single or multiple repetition of (IX) and (X); and
(XII) optionally, applying a protective layer, an adhesive layer, and/or a release layer to the layer obtained in (V), (VII), (VIII), (X) or (XI).

33. A process for producing the thermally insulating film of claim 1, the process comprising:
(i) providing the film;
(ii) if the film has been concluded by a carrier film or a protective film on both sides, detaching one of the carrier films or the protective film;
(iii) applying the film provided in (i) or (ii) to a new carrier film; and
(iv) transferring the layers of the new film.

34. A heat management system comprising the film of claim 1 or a composition comprising a compound of formula (IV.c): 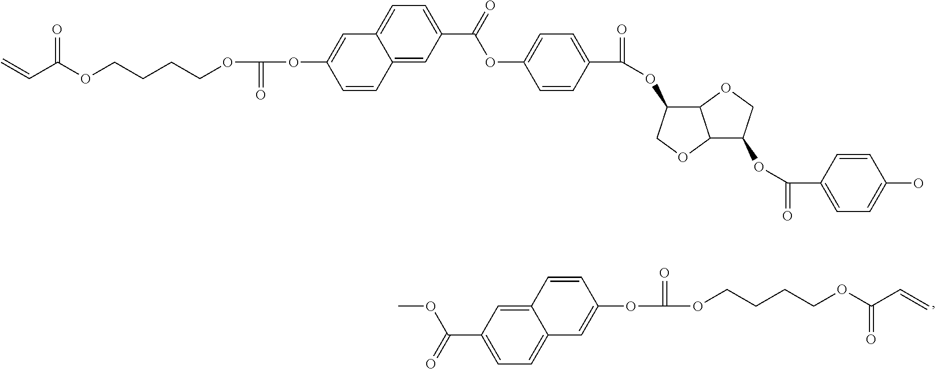
and at least one achiral nematic polymerizable monomer.
